(19) United States
(12) Patent Application Publication
(10) Pub. No.: US 2009/0180451 A1
(43) Pub. Date: Jul. 16, 2009

(54) APPARATUS FOR AND METHOD OF COORDINATING TRANSMISSION AND RECEPTION OPPORTUNITIES IN A COMMUNICATIONS DEVICE INCORPORATING MULTIPLE RADIOS

(75) Inventors: Yaron Alpert, Hod Hasharon (IL); Jonathan Segev, Tel Mond (IL); Ehud Reshef, Qiryat Tivon (IL)

Correspondence Address: Zaretsky Patent Group PC, 20783 N 83rd Ave, Ste 103-174, Peoria, AZ, 85382-7430, US

(73) Assignee: Comsys Communication & Signal Processing Ltd.

(21) Appl. No.: 12/349,758

(22) Filed: Jan. 7, 2009

Related U.S. Application Data
(60) Provisional application No. 61/020,213, filed on Jan. 10, 2008.
(60) Provisional application No. 61/092,152, filed on Aug. 27, 2008.

(51) Int. Cl. H04W 84/10

(52) U.S. Cl. 370/338

(57) ABSTRACT

A novel and useful apparatus for and method of coordinating the allocation of transmission and reception availability and/or unavailability periods for use in a communications device incorporating collocated multiple radios. The mechanism provide both centralized and distributed coordination to enable the coordination (e.g., to achieve coexistence) of multiple radio access communication devices (RACDs) collocated in a single device such as a mobile station. A distributed activity coordinator modifies the activity pattern of multiple RACDs. The activity pattern comprises a set of radio access specific modes of operation, (e.g., IEEE 802.16 Normal, Sleep, Scan or Idle modes, 3GPP GSM/EDGE operation mode (PTM, IDLE, Connected, DTM modes), etc.) and a compatible set of wake-up events, such as reception and transmission availability periods. To prevent interference and possible loss of data, a radio access is prevented from transmitting or receiving data packets while another radio access is transmitting or receiving. In the event two or more RATs desire to be active at the same time, the mechanism negotiates an availability pattern between the MS and a corresponding BS to achieve coordination between the RATs.

### REFERENCE TO PRIORITY APPLICATIONS

This application claims priority to U.S. Provisional Application Ser. No. 61/020,213, filed Jan. 10, 2008, entitled “Distributed Coexistence Coordination of Collocated Multiple Radio Access Communication Systems,” and to U.S. Provisional Application Ser. No. 61/092,152, filed Aug. 27, 2008, entitled “Distributed Coexistence Coordination of Collocated Multiple Radio Access Communication Systems,” both of which are incorporated herein by reference in their entirety.

### FIELD OF THE INVENTION

The present invention relates generally to wireless communication systems and more particularly relates to an apparatus for and method of coordinated transmission and reception allocations of availability periods for use in a communications device incorporating collocated multiple radios.

### BACKGROUND OF THE INVENTION

Currently there are numerous consumer electronics devices such as portable multimedia players, add-ons for portable multimedia players, cellular telephones, personal digital assistants (PDAs), personal navigation device (PND), etc., that incorporate multiple radios for supporting multiple communications connections. Considering communication devices such as cellular phones, for example, an increasing number of cellular phones today support several long range communications connections such as WiMAX, GSM, GPRS, EDGE, UMTS, HSPA, CDMA, EVDO, Wireless Local Area Network (WLAN) and short range communications connections such as Bluetooth, UWB, IR, etc. Many of these connection types and standards are expected to be incorporated into mobile devices in the next several years such that one or more of these connections may be active at the same time.

An increasing number of modern electronic devices incorporate multiple radios. Such electronic devices are capable of using more than one radio frequency (RF) device for wireless access or networking to provide connectivity in a wide range of environments, making these devices more convenient for users. A particularly interesting optional feature of such multi-radio devices is the capability to provide service continuity in a multi-radio access technology environment. An electronic device that can communicate over multiple radio access and networking protocols can reduce the number of electronic devices that users need to carry around For example, an electronic device, such as a cellular phone or personal digital assistant (PDA) can communicate using a cellular Wireless Wide Area Network (WWAN) such as Code Division Multiple Access (CDMA), GSM, UMTS, HSPA, EVDO, etc.; a Wireless Personal Area Network (WPAN) such as Bluetooth, Ultra Wide Band (UWB), wireless USB (wUSB), etc.; a short range Wireless Local Area Network (WLAN) such as WiFi, etc.; a Wireless Metropolitan Area Network (WMAN) such as WiMAX, as well as other wireless technologies, e.g., Global Positioning Satellite (GPS), Near Field Communication (NFC), Digital Video Broadcast (DVB), etc. Therefore, a single electronic device can replace two, three or more devices, such as a cellular phone, PDA, PND, laptop computer, etc.

As semiconductor manufacturing advances, communication device manufacturers are integrating more and more radios into the same communications device or onto the same integrated circuit. In order for radios to be integrated onto the same chip or device, it is critical that the transmission and reception times be coordinated. This is an important issue in the design of multi-radio systems that is gaining in criticality of operation as the number of collocated radios increases with time.

As an example, consider the block diagram illustrating an example prior art multi-radio communications device as shown in FIG. 1. This example multi-radio communications device, generally referenced 11, comprises a plurality of radios, including various cellular and connectivity specific radios such as Global System for Mobile communications (GSM) (and/or UMTS, HSPA, LTE, etc.) 13, Global Positioning System (GPS) 15 (receive only), Frequency Modulation (FM) radio 17 (receive and possibly transmit), Bluetooth 19, Near Field Communications (NFC) 23, and Wireless Local Area Network (WLAN) (and/or WWAN, WPAN, etc.) 21.

Having multiple radios in a single device provides benefits and advantages to users by enabling the operation of several radios simultaneously. For example, a user may be listening to an FM radio station over a Bluetooth headset while using the GPS radio to navigate to a destination and communicate over a wireless link.

Currently there are numerous connected consumer electronics devices such as Portable Multimedia Players (PMPs), add-ons for portable multimedia players, cell phones, PDAs, etc. that support advanced access services like Voice over IP (VoIP), unicast and multicast multimedia services, where each of these new services have very different traffic characteristics. In order to efficiently provide the multi-characteristic service, there is need for a resource allocation coordination and tuning mechanism to achieve a level of coexistence that takes into account continuous and simultaneous operation of uplink and downlink transmissions in different radio interfaces according to the required service characteristics.

One of the key aspects affecting the user experience in mobile devices is battery life. Advanced radio access communication systems support state of the art Sleep and Idle modes to enable power-efficient mobile station (MS) operation. Sleep and Idle modes are operation methodologies in which an MS pre-negotiates inactivity periods with the Serving Base Station (SBS). These periods are characterized by the unavailability of the MS to the SBS for downlink (DL) traffic, uplink (UL) traffic or both. In general, Idle mode is typically used when a long unavailability period is required or when Sleep mode functionality is absent. A different type of unavailability negotiation uses the Scan methodology. The Scan methodology is used to allocate specific unavailability periods that might allow for the radio to detect, measure or connect to other radio channels (on the same or other technology) to allow for an efficient handover process. Currently, Sleep, and Idle modes are used for the minimization of MS power consumption as well as the consumption of the SBS air interface resource and Scan is used for handover (HO) purposes only. It is noted that each and every radio access technology has its own specific terms and mechanism for the Sleep, Scan, and Idle mode functionality.

In the case of multiple radio systems, if the radio access technologies utilize multiple frequency bands that are spaced far enough apart, then good RF design and the use of relatively simple filtering techniques could prevent any interaction from occurring between the signals of the different radio access technologies. In other words, the different radio access technologies can coexist without interfering with one another. If, on the other hand, the frequency bands used for these radio access methodologies are close or overlap, then the transmissions (or receptions) of a first radio access methodologies are likely to interfere with the transmission or reception of a second radio system. In these cases, some type of coordination technique should be implemented.

Prior art attempts to address the coexistence problem exist. The several different classes of prior art coordination techniques handle coexistence mainly using transmission collision detection techniques. A first class of prior art techniques can be classified as collision recovery. In this first class, collision is permitted and a recovery mechanism is implemented in order to overcome the collision effects. A main disadvantage of the collision recovery mechanism is that there is (1) a reduction in the total available bandwidth (BW); (2) a reduction in the transmission reliability; and (3) degradation in QoS due to collisions. Therefore, when the collision rate is high enough, it may not be possible to effectively maximize the utilization of the available transmission bandwidth, preserve the required QoS or to even maintain a viable link.

A second class of prior art techniques can be classified as collision avoidance. In this second class, collisions are not allowed in the first place. One disadvantage of prior art collision avoidance techniques is that their passive approach results in complications in coordinating in real time the different radio access technologies. Therefore, prior art collision avoidance techniques do not attempt to actually prevent collisions from occurring but rather try to reduce the probability of collision. Thus, collisions can and still do occur.

A problem with current radio access communication technologies is that they do not support flexible assignments of irregular transmission and reception availability and/or unavailability patterns nor multi-technology coordination of availability and/or unavailability patterns. As an example, the current IEEE 802.16 Wireless Metropolitan Area Network (WMAN) (also referred to as WiMAX) specification includes three different types of Sleep mode power save schemes. None of these three schemes, however, support a flexible or irregular assignment for transmission and/or reception opportunities.

Thus, there is a need for a mechanism for detecting, coordinating and synchronizing the transmission and reception allocations of availability and unavailability periods of multiple collocated radio access communication systems. The transmission and reception detection, coordination and synchronization scheme should achieve a level of coexistence between the multiple radio access technologies collocated in the same device, integrated circuit or SoC. The scheme for allocations of availability and/or unavailability periods for transmission and reception should preferably be able to avoid the shortcomings of prior art collision avoidance and detection techniques.

### SUMMARY OF THE INVENTION

Accordingly, the present invention provides a novel and useful apparatus for and method of coordinating transmission and reception availability periods for use in a communications device incorporating collocated multiple radios. The coordination mechanism is based on analyzing activity and/or inactivity patterns of radio access devices. These may be obtained by (1) detecting activity patterns, (2) radio access units conveying their activity pattern, inactivity pattern and/or restrictions to a centralized or distributed coordination manager, or (3) using a synchronization procedure whereby RF signals, messages, etc., are detected (e.g., using RF sniffers) and further analyzed to determine activity pattern information. The coordination mechanism for allocation of availability and unavailability TX/RX periods can be used to achieve a level of coexistence between multiple radio access technologies (RATs) collocated in a mobile station (MS). The coordination mechanism of the present invention is particularly adapted for use in cases where simple RF filtering techniques are not sufficient or cost effective to allow for simultaneous operation of multiple collocated radios. Such a situation may occur when the receive chain of one or more of the radio transceivers is blocked or subject to degraded sensitivity while another transceiver is in operation.

Use of the mechanism of the present invention enables a communications device to accommodate the collocation of multiple radio accesses that (1) share the same, overlapping or adjacent radio spectrum in the same device; (2) share one or more components (e.g., transceivers, front-end modules, memory, processor, battery, power amplifier (PA), antenna, etc); and/or (3) transfer data between a BS and a MS in a coexistent manner with other RATs.

To aid in illustrating the principles of the present invention, an example mobile station is described in connection with coordination of multiple radio access communication protocols collocated within a mobile device. As an example, the mobile station comprises GSM, WiMAX and WLAN radio access communication devices (RACDs). The mobile device is capable of maintaining communications with more than one wireless communications system at the same time and may comprise any desired RAT including, for example, WiMAX, UWB, GSM, wUSB, Bluetooth, WLAN, 3GPP (UMTS, WCDMA, HSPA, HSUPA, HSDPA, LTE), 3GPP2 (CDMA2000, EVDO, EVDV), DVB and others. Note that the invention is not intended to be limited by the type or number of radio access communication devices (RACDs) in the MS.

In operation, a single MS may contain multiple communication components (e.g., 2G cellular, 3G cellular, WiMAX, WLAN, Bluetooth, etc.). To prevent interference and possible loss of data, one communication radio access can be prevented from transmitting or receiving data packets while another radio access module is either transmitting or receiving. In the event two or more RATs desire to be active at the same time, the mechanism is operative to determine, and where applicable negotiate an availability pattern between the MS and a corresponding BS to achieve coexistence between the various wireless access technologies.

The MS of the present invention is capable of communicating with a first radio access network (RAN) and a second RAN, as well as potentially several other RANs via collocated radio transceivers. The MS comprises a first coordination manager associated with the first RAN and a second coordination manager associated with the second RAN and potentially other coordination managers associated with other RANs. The coordination managers of the second and other RANs receiving allocations of potentially irregularly reserved availability periods and/or other restrictions from the coordination manager of the first RAN and select an operating mode and an allocation of availability and/or unavailability periods for transmission and/or reception based thereon. Messages are transferred between first RAN and the second RAN based on the allocation of potentially irregular availability periods, unavailability periods and/or restrictions for each radio access network. Examples of such restrictions include, for example, TX power, modulation, bandwidth, etc.

The mechanism enables an MS to communicate with two or more RANs, where communications on a first RAN may occur during coordinated times. The MS receives a message from a coordination manager of the first RAN, where the message contains allocations of availability periods, available transfer times (receive and transmit) and/or unavailable transfer times, and provides restrictions to a coordination manager associated with second or other RANs in the MS. The message transfers on the second or other RANs are based on the available transfer times and/or unavailable transfer times provided by the first RAN. Messages are also transferred on the first RAN based on the restrictions of the first RAN while message transfer on the second or other RANs are based on their respective restrictions.

The coordination mechanism may be based on the use of Sleep, Scan or Idle mode communication protocols and methods (referred to as Sleep, Scan or Idle mode methods) and on notification or detection of their use. Such Sleep, Scan or Idle mode methods implement a repeated process of queuing (e.g., by buffering or caching) information during an unavailability time, taking into account QoS requirements and constraints, and commencing the transmission of the queued (or buffered) information during the availability period (e.g., time slots, frames, etc.) in a burst transmission and/or reception manner, with a subsequent return to the unavailability duration to queue further information for subsequent burst transmission and/or reception during the next radio access availability period.

The radio access module, employing certain Sleep, Scan or Idle mode methods, buffers information in memory. The information is sent out as a contiguous packet burst with minimal inter-time slot allocations according to the instructions of a central controller or a radio access module coordinator.

The mechanism may also request the assignment of irregular transmission and reception availability patterns, reassignment or modification of at least one availability period in the pattern assigned to a first RAT in a flexible manner. Data packet transmission and reception is canceled or generated in response to the request and assigning (or reassigning) of at least one period (e.g., time slot, frame, etc.) within the availability pattern to the second RAT based upon the request of the controller or coordinated methodology.

The mechanism may also comprise the detection, configuration and/or reconfiguration of transmission and reception availability patterns of a first RAT by a centralized coordination manager or in a distributed fashion, by coordination managers associated with other RATs. The coordination manager requests the assignment of a possibly irregular transmission and/or reception availability pattern, a reassignment of this pattern or the modification thereof in order to avoid a conflict (collision) with the first RAT.

The mechanism may also comprise determining a flexible frequency domain irregular transmission and reception availability pattern for a first RAT and filtering the radio access communications according to the first RAT utilizing a null filter in frequency, time and/or spherical domains in order to avoid interference (collisions) with radio access communications of a second (or other) RAT.

In accordance with another embodiment of the invention, the Sleep, Scan and/or Idle mode configurations of every radio access module described herein provides for a repeated regular or irregular process of unavailability times where information is queued for transmission and/or reception at the next availability time during which information is transmitted and/or received in a burst manner (high volume of data frames separated by minimal inter-frame space). Systems supporting such configurations thus benefit from reduced transitioning between unavailability and availability periods, which often result in a significant reduction in interference level to other collocated radio access modules, thus improving performance.

According to another embodiment, a radio access communication device (RACD) may comprise a processor configured to control communications of a first RAT and second or other RATs. The processor is further configured to control and coordinate the transmission and reception allocations of a first RAT according to the second or other RAT to avoid conflict (collision) with transmission or reception allocations assigned to one or more of the second or other RATs. The processor can request the assignment, reassignment or modification of the flexible irregular transmission and reception availability patterns assigned to the first, second or other RATs.

The transmission/reception coordination mechanism provides several advantages and benefits, including: (1) the ability to achieve coexistence between multiple RATs using existing capabilities of the radio access communications systems and without requiring any modifications to the radio access communications systems; (2) the mechanism being active in nature, allows the bandwidth allocation to be partitioned based on the requirements of the radio access communications systems.; (3) the potential ability to reduce hardware requirements in supporting multiple collocated radio access communications systems, resulting in (4) a reduction in overall hardware cost and increased consumer adoption, and in (5) a reduction in the size of the hardware, allowing for smaller devices; and (6) reduced probability of failure thereby increasing the reliability of the hardware and an overall increase in network capacity.

Many aspects of the invention described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, etc., or non-real time operating systems such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method of transmission and reception coordination for use with a plurality of radio access technologies (RATs) including a first RAT with a first activity pattern, the method comprising the steps of determining at least one candidate second activity pattern for transmission and/or reception opportunities/avoidance to a second RAT based on the first activity pattern and enabling operation of the second RAT in accordance with the candidate second activity pattern.

There is also provided in accordance with the invention, a method of transmission and reception allocation of availability periods for multiple radio access technologies (RATs) in a single communication device, the method comprising the steps of determining a first activity pattern for a first RAT, determining a proposed second activity pattern for a second RAT based on the first activity pattern and zero or more constraints of the second RAT and negotiating an activity mode with a second RAT network element to meet the proposed second activity pattern.

There is further provided in accordance with the invention, a method of transmission and reception allocation of availability periods for multiple radio access technologies (RATs) in a single communication device, the method comprising the steps of determining a first activity pattern for a first RAT, determining a proposed second activity pattern for a second RAT based on the first activity pattern and zero or more constraints of the second RAT and negotiating an activity mode with a first RAT network element to meet the proposed first activity pattern.

There is also provided in accordance with the invention, a method of transmission and reception coordination of allocation of availability periods for use in a multiple radio access technology (multi-RAT) device, the method comprising the steps of determining requested activity patterns and/or modes of operation of a plurality of RATs by a central coordination controller, calculating an operating mode and transmission allocation of availability periods for each respective RAT based on the activity patterns and/or modes of operation of respective RATs and TX/RX priority of the plurality of RATs and configuring the plurality of RATs in accordance with each respective calculated operating mode and transmission allocation of availability periods.

There is further provided in accordance with the invention, an apparatus for transmission and reception coordination of allocation of availability periods of multiple radio access technologies (RATs) incorporated within a communications device comprising a plurality of distributed coordination managers, each coordination manager associated with a RAT, an analysis unit associated with each coordination unit and operative to determine an allocation of availability periods based on TX/RX availability periods of other RATs in the device and TX/RX priority of the RATs and enabling operation of a respective RAT in accordance with a corresponding the determined allocation of availability periods.

There is also provided in accordance with the invention, an apparatus for coordinating transmission and reception allocation of availability periods of multiple radio access technologies (RATs) incorporated within a communications device comprising a centralized coordination manager operative to determine one or more allocations of availability periods based on determined activity patterns of a plurality of RATs in the device and TX/RX priority of the RATs and enabling operation of one or more RATs in accordance with corresponding the determined allocations of availability periods.

There is further provided in accordance with the invention, a communications device comprising a first radio transceiver and associated media access control (MAC) operative to receive and transmit signals over a first radio access network (RAN) using a first wireless access, a second radio transceiver and associated MAC operative to receive and transmit signals over a second RAN using a second wireless access, a coordination manager for determining at least one candidate second activity pattern for transmission and/or reception opportunities/avoidance to a second RAN based on the first activity pattern, enabling operation of the second RAN in accordance with the candidate second activity pattern and a processor operative to send and receive data to and from the first radio transceiver and the second radio transceiver.

There is also provided in accordance with the invention, a computer-readable medium having computer readable instructions stored thereon for execution by a processor to perform a method of transmission and reception allocation of availability periods for use with a plurality of radio access technologies (RATs) including a first RAT with a first activity pattern, the method comprising the steps of determining at least one candidate second activity pattern for transmission and/or reception opportunities/avoidance to a second RAT based on the first activity pattern and enabling operation of the second RAT in accordance with the candidate second activity pattern.

### BRIEF DESCRIPTION OF THE DRAWINGS

The invention is herein described, by way of example only, with reference to the accompanying drawings, wherein:

FIG. 1 is a block diagram illustrating an example prior art multi-radio communications device;

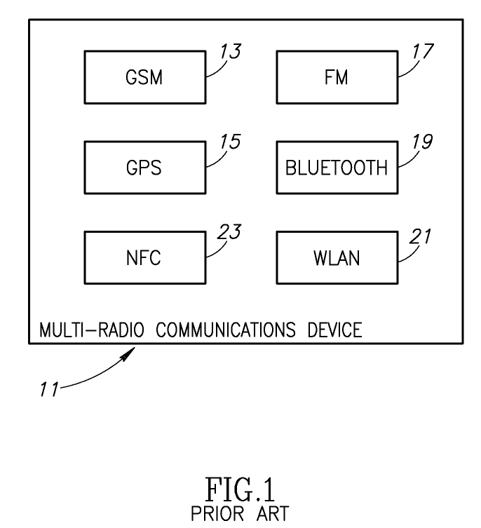

FIG. 2 is a block diagram illustrating a multiple radio access communication device incorporating the transmission and reception mechanism of the present invention for allocating availability and unavailability periods;

FIG. 3 is a diagram illustrating an example network including multiple radio access communication systems;

FIG. 4 is a diagram illustrating an example network incorporating WiMAX, WLAN, GSM and Bluetooth radios;

FIG. 5 is a diagram illustrating an example collocated multiple radio mobile station in a coexistence communication environment;

FIG. 6 is a diagram illustrating an example collocated coordination system of the present invention;

FIG. 7 is a flow diagram illustrating the method for allocation of availability and unavailability transmission and reception periods of the present invention;

FIG. 8 is a flow diagram illustrating the MAC level coordination method of the present invention;

FIG. 9 is a timing diagram illustrating the timing relationship between GSM, WiMAX and WLAN activity patterns; and

FIG. 10 is a block diagram illustrating an example computer processing system adapted to implement the transmission/reception coordination mechanism of the present invention.

### DETAILED DESCRIPTION OF THE INVENTION

### Notation Used Throughout

The following notation is used throughout this document.

| Term | Definition |
|---|---|
| 3GPP | Third Generation Partnership Project |
| AC | Alternating Current |
| AP | Access Point |
| ARQ | Automatic Repeat-reQuest |
| ASIC | Application Specific Integrated Circuit |
| AVI | Audio Video Interleave |
| BS | Base Station |
| BTS | Base Transmit Station |
| BW | Bandwidth |
| BWA | Broadband Wireless Access |
| CDMA | Code Division Multiple Access |
| CPU | Central Processing Unit |
| CS | Circuit Switched |
| DC | Direct Current |
| DL | Downlink |
| DL-MAP | Downlink Medium Access Protocol |
| DSL | Digital Subscriber Loop |
| DSSS | Direct Sequence Spread Spectrum |
| DVB | Digital Video Broadcast |
| DVD | Digital Versatile Disc |
| EDGE | Enhanced Data rates for GSM Evolution |
| EVDO | Evolution-Data Optimized |
| FDMA | Frequency Division Multiple Access |
| FEM | Front End Module |
| FH | Frequency Hopping |
| FHSS | Frequency Hopping Spread Spectrum |
| FM | Frequency Modulation |
| FPGA | Field Programmable Gate Array |
| GPRS | General Packet Radio Service |
| GPS | Global Positioning Satellite |
| GSM | Global System for Mobile Communication |
| HARQ | Hybrid ARQ |
| HDL | Hardware Description Language |
| HSPA | High Speed Packet Access |
| IEEE | Institute of Electrical and Electronic Engineers |
| IP | Internet Protocol |
| IR | Infrared |
| JPG | Joint Photographic Experts Group |
| LAN | Local Area Network |
| LTE | Long Term Evolution |
| MAC | Media Access Control |
| MAP | Medium Access Protocol |
| MBS | Multicast and Broadcast Service |
| MP3 | MPEG-1 Audio Layer 3 |
| MPG | Moving Picture Experts Group |
| MS | Mobile Station |
| NFC | Near Field Communication |
| OFDM | Orthogonal Frequency Division Modulation |
| OFDMA | Orthogonal Frequency Division Multiple Access |
| PAN | Personal Area Network |
| PC | Personal Computer |
| PCA | Personal Computing Accessory |
| PCI | Peripheral Component Interconnect |
| PCS | Personal Communication System |
| PDA | Personal Digital Assistant |
| PDU | Protocol Data Unit |
| PMP | Portable Multimedia Player |
| PNA | Personal Navigation Assistant |
| PND | Personal Navigation Device |
| PRBS | Pseudo Random Binary Sequence |
| PROM | Programmable Read Only Memory |
| PSTN | Public Switched Telephone Network |
| QAM | Quadrature Amplitude Modulation |
| QoE | Quality of Experience |
| QoS | Quality of Service |
| RACD | Radio Access Communications Device |
| RAM | Random Access Memory |
| RAN | Radio Access Network |
| RANI | Radio Access Network Interface |
| RAT | Radio Access Technology |
| RF | Radio Frequency |
| ROM | Read Only Memory |
| SBS | Serving Base Station |
| SDIO | Secure Digital Input/Output |
| SIM | Subscriber Identity Module |
| SIP | Session Initiation Protocol |
| SPI | Serial Peripheral Interface |
| STC | Space Time Code |
| TDMA | Time Division Multiple Access |
| TV | Television |
| UMTS | Universal Mobile Telecommunications System |
| UPSD | Unscheduled Power Save Delivery |
| USB | Universal Serial Bus |
| UWB | Ultra Wideband |
| WCDMA | Wideband Code Division Multiple Access |
| WiFi | Wireless Fidelity |
| WiMAX | Worldwide Interoperability for Microwave Access |
| WLAN | Wireless Local Area Network |
| WLL | Wireless Local Loop |
| WMA | Windows Media Audio |
| WMAN | Wireless Metropolitan Area Network |
| WMV | Windows Media Video |
| WPAN | Wireless Personal Area Network |
| wUSB | Wireless USB |
| WWAN | Wireless Wide Area Network |

### DETAILED DESCRIPTION OF THE INVENTION

Accordingly, the present invention provides a novel and useful apparatus for and method of detection, coordination and synchronization of allocations of transmission and reception availability and unavailability periods for use in a communications device incorporating collocated multiple radios. The mechanism for coordinating TX/RX periods (using detection, conveyance or synchronization operations) can be used to achieve a level of coexistence between multiple radio access technologies (RATs) collocated in a communication device such as a mobile station (MS). The coordination mechanism is particularly adapted for use in cases where simple RF filtering techniques are not sufficient or cost effective to allow for simultaneous operation of multiple collocated radios. Such a situation may occur when the receive chain of one or more of the radio transceivers is blocked or subject to degraded sensitivity while another transceiver is in operation.

To aid in illustrating the principles of the present invention, an example mobile station is described in connection with coordination of multiple radio access communication protocols collocated within a mobile device. As an example, the mobile station comprises GSM, WiMAX and WLAN radio access communication devices (RACDs). The mobile device is capable of maintaining communications with more than one wireless communications system at the same time and may comprise any desired RAT including, for example, WiMAX, UWB, GSM, wUSB, Bluetooth, WLAN, 3GPP (UMTS, WCDMA, HSPA, HSUPA, HSDPA, LTE), 3GPP2 (CDMA2000, EVDO, EVDV), DVB and others.

Further, the present invention is described in the context of a preferred embodiment of radio access modules that can be coordinated by a central controller located in the MS. In other embodiments, the radio access modules exchange messages or signals between themselves in order to detect, determine, coordinate and synchronize transmission and or reception periods. In addition, radio access modules can monitor the status of other radio access modules to update their policy accordingly.

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media. Examples of wireless media include RF, infrared, optical, microwave, UWB, Bluetooth, WiMAX, GSM, EDGE, UMTS, WCDMA, LTE, CDMA-2000, EVDO, EVDV, WiFi, or any other broadband medium, radio access technology (RAT), etc.

The term mobile station is defined as all user equipment and software needed for communication with a network such as a RAN. Examples include a system, subscriber unit, mobile unit, mobile device, mobile, remote station, remote terminal, access terminal, user terminal, user agent, user equipment, etc. The term mobile station is also used to denote other devices including, but not limited to, a multimedia player, mobile communication device, node in a broadband wireless access (BWA) network, smartphone, PDA, PND, Bluetooth device, cellular phone, smart-phone, handheld communication device, handheld computing device, satellite radio, global positioning system, laptop, cordless telephone, Session Initiation Protocol (SIP) phone, wireless local loop (WLL) station, handheld device having wireless connection capability or any other processing device connected to a wireless modem. A mobile station normally is intended to be used in motion or while halted at unspecified points but the term as used herein also refers to devices fixed in their location.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.). The user input means is typically formed of one or more manually operated switches, buttons, wheels or other user input means. Examples of multimedia devices include pocket sized personal digital assistants (PDAs), personal navigation assistants (PNAs), personal navigation devices (PNDs), personal media player/recorders, cellular telephones, handheld devices, and the like.

The term radio access communications device, radio access communications system or radio access communications transceiver is defined as any apparatus, device, system or mechanism adapted to transmit, receive or transmit and receive data through a medium. The communications device or communications transceiver may be adapted to communicate over any suitable medium, including wireless or wired media.

The term ‘detection’ refers to the detection of transmission and/or reception activities of another radio access device (RACD). The term ‘synchronization’ refers to the synchronization of transmission and/or reception periods of more than one radio access device (RACD) based on the results of deciphering the operational modes of each RACD. The term RF coexistence is defined to mean coexistence between two or more radio access technologies (RATs) in terms of frequency spectrum usage and time access.

The term ‘coordination mechanism’ refers to the coordination of transmission/reception allocations of multiple radio transceivers which refers to (1) detecting, synchronizing or obtaining (such as by conveyance from a radio transceiver) reception and/or transmission allocations from a first RAN, as well as additional information related to tagging the allocations with priority information, required QoS, current connection channel quality, connection status or state; (2) selecting an operating mode for the associated coordination manager; and (3) coordinating it with a second RAN by setting the operating mode of the mobile station (MS) based on the coordination mechanism.

Throughout this document, the term availability pattern is intended to refer to availability pattern and/or unavailability pattern. Similarly, the term availability period is intended to refer to availability period and/or unavailability period. Further, the term activity pattern is intended to refer to activity pattern and/or inactivity pattern.

The word ‘exemplary’ is used herein to mean ‘serving as an example, instance, or illustration.’ Any embodiment described herein as ‘exemplary’ is not necessarily to be construed as preferred or advantageous over other embodiments.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices or to a hardware (logic) implementation of such processes.

The invention can take the form of an entirely hardware embodiment, an entirely software embodiment or an embodiment containing a combination of hardware and software elements. In one embodiment, a portion of the mechanism of the invention can be implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (embedded or removable in the form of, e.g., USB flash drive, SDIO module, etc.), ROM, EPROM, or other semiconductor memory devices.

### Multiple Radio Access Communications Device Incorporating the Mechanism for Allocating TX/RX Availability and Unavailability Periods

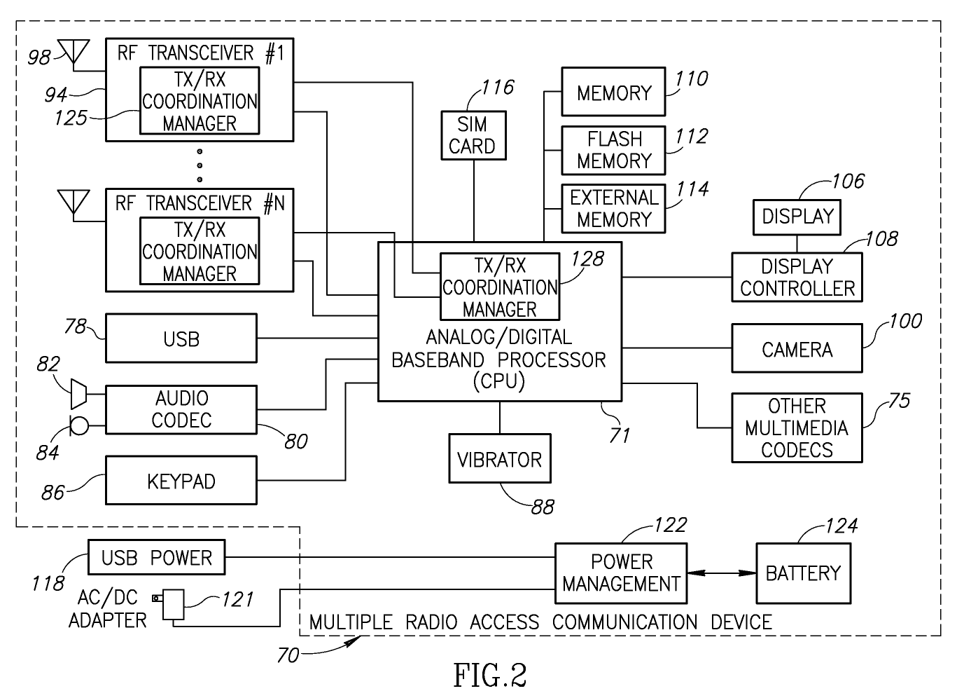

A diagram illustrating a multiple radio access communication device incorporating the mechanism of the present invention for allocating transmission and reception availability and unavailability periods is shown in FIG. 2. Note that the communication device may comprise any suitable wired or wireless device such as mobile station, multimedia player, mobile communication device, cellular phone, smartphone, PDA, PNA, PND, Bluetooth device, etc. For illustration purposes only, the device is shown as a mobile device, such as a cellular phone. Note that this example is not intended to limit the scope of the invention as the coordination mechanism of the present invention can be implemented in a wide variety of communication devices.

The mobile device, generally referenced 70, comprises a processor or CPU 71 having analog and digital baseband portions and an application portion. The mobile device may comprise a plurality of RF transceivers 94 and associated antennas 98. RF transceivers for the basic cellular link and any number of other wireless standards and Radio Access Technologies (RATs) may be included. Examples include, but are not limited to, cellular technologies such as Global System for Mobile Communication (GSM), GPRS, EDGE, CDMA, EVDO, EVDV, WCDMA, HSPA, LTE; WiMAX for providing WiMAX wireless connectivity when within the range of a WiMAX wireless network; Bluetooth for providing Bluetooth wireless connectivity when within the range of other Bluetooth devices; WLAN for providing wireless connectivity when in a hot spot or within the range of an ad hoc, infrastructure or mesh based wireless LAN network; near field communications; UWB; FM to provide the user the ability to listen to FM broadcasts as well as the ability to transmit audio over an unused FM station at low power, such as for playback over a car or home stereo system having an FM receiver, GPS, TV tuner, etc. One or more of the RF transceivers may comprise additional antennas to provide antenna diversity which yields improved radio performance. The mobile device may also comprise internal RAM and ROM memory 110, Flash memory 112 and external memory 114.

Several user-interface devices include microphone(s) 84, speaker(s) 82 and associated audio codec 80 or other multimedia codecs 75, a keypad or touchpad 86 for entering dialing digits and for other controls and inputs, vibrator 88 for alerting a user, camera and related circuitry 100 and display(s) 106 and associated display controller 108. A USB or other interface connection 78 (e.g., SPI, SDIO, PCI, etc.) provides a serial link to a user's PC or other device. An optional SIM card 116 provides the interface to a user's SIM card for storing user data such as address book entries, user identification, etc.

The RF transceivers 94 also comprise TX/RX coordination managers 125 constructed in accordance with the present invention which is in communication with a centralized TX/RX coordination manager 128. The TX/RX coordination managers 125, 128 are adapted to implement the TX/RX coordination mechanism of the present invention as described in more detail infra. The TX/RX coordination mechanism of the present invention can be implemented either in a distributed, centralized or hybrid manner. The TX/RX coordination manager 128 facilitates a centralized implementation while TX/RX coordination manager 125 facilitates a distributed implementation. Hybrid implementations apportion implementation of the mechanism between the coordination manager 125 in the RF transceivers 94 and the centralized coordination manager 128. In operation, the TX/RX coordination mechanism may be implemented as hardware, software or as a combination of hardware and software. Implemented as a software task, the program code operative to implement the TX/RX coordination mechanism of the present invention is stored in one or more memories 110, 112 or 114 or local memories within the baseband.

Portable power is provided by the battery 124 coupled to power management circuitry 122. External power is provided via USB power 118 or an AC/DC adapter 121 connected to the battery management circuitry 122, which is operative to manage the charging and discharging of the battery 124.

### Example Network Incorporating Multiple Radio Access Communications Systems

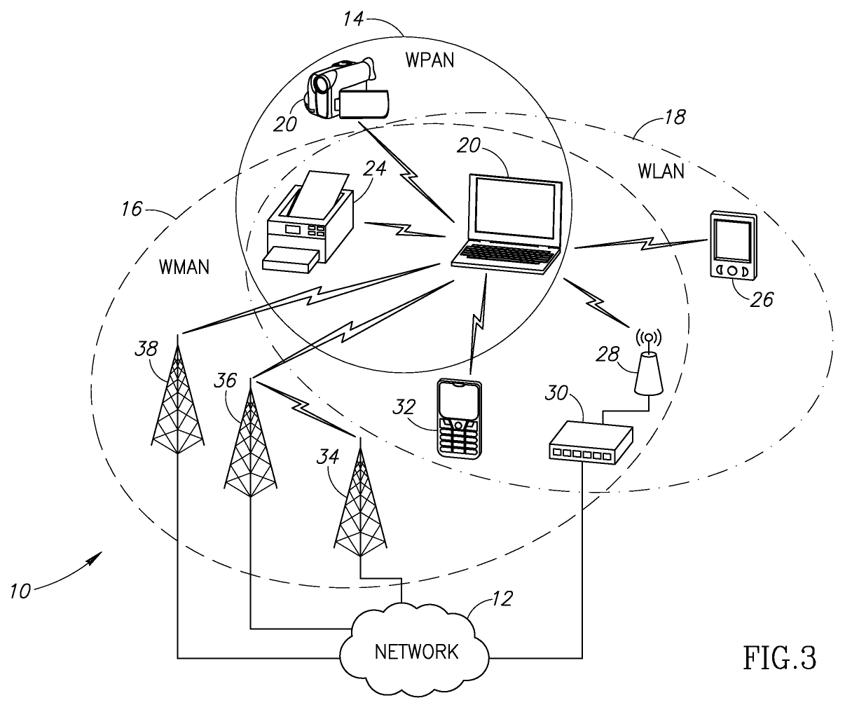

A diagram illustrating an example network including multiple radio access communication systems is shown in FIG. 3. The example system, generally referenced 10, comprises a plurality of radio access communication networks, 14, 16 and 18. In this example, the system 10 comprises a wireless personal area network (WPAN) 14 (e.g., Bluetooth), a wireless local area network (WLAN) 18 and a wireless metropolitan area network (WMAN) 16 (e.g., WiMAX). The system 10 may comprise any number of radio access communication networks. For example, the system may comprise additional WPANs, WLANs, and/or WMANs.

The communication system may also comprise one or more mobile stations (MSs), including video camera 20, laptop computer 22, printer 24, handheld computer (e.g., PDA, etc.) 26 and cellular phone (e.g., smartphone) 32. The MSs 20, 22, 24, 26, 32 may comprise, for example, radio access electronic devices such as a desktop computer, laptop computer, handheld computer, tablet computer, cellular telephone, pager, audio and/or video player (e.g., MP3/4 player or a DVD player), gaming device, video camera, digital camera, PND, wireless peripheral (e.g., printer, scanner, headset, keyboard, mouse, etc.), medical device (e.g., heart rate monitor, blood pressure monitor, etc.), and/or any other suitable fixed, portable or mobile electronic devices. It is appreciated that although the system 10 is shown in this example having five mobile stations, it may comprise any number of mobile stations.

The mobile stations 20, 22, 24, 26 and 32 are operative to use any of a variety of modulation techniques such as spread spectrum modulation, single carrier modulation or Orthogonal Frequency Division Modulation (OFDM), etc., and multiple access techniques such as Direct Sequence Code Division Multiple Access (DS-CDMA), Frequency Hopping Code Division Multiple Access (FH-CDMA)), Time-Division Multiple Access (TDMA), Frequency-Division Multiple Access (FDMA), Orthogonal Frequency Division Multiple Access (OFDMA), and/or other suitable modulation techniques to communicate via wireless links. In one example embodiment, the laptop computer 22 operates in accordance with wireless communication protocols that require very low power such as Bluetooth, (UWB), and/or radio frequency identification (RFID) to implement the WPAN 14. For example, the laptop computer 22 can communicate with devices associated with the WPAN such as the video camera 20 and/or the printer 24 via radio access links.

Alternatively, the laptop computer may use Direct Sequence Spread Spectrum (DSSS) modulation and/or Frequency Hopping Spread Spectrum (FHSS) modulations to implement the WLAN 18 (e.g., the 802.11 family of standards developed by the Institute of Electrical and Electronic Engineers (IEEE) and/or variations and evolutions of these standards). For example, the laptop computer may communicate with devices associated with the WLAN 18 such as the printer 24, handheld computer 26 and/or the smartphone 32 via wireless links. The laptop computer can also communicate with a WLAN access point (AP) 28 via a wireless link. The AP is operatively coupled to a router 30 as described in more detail infra. Alternatively, the AP and the router may be integrated into a single device (e.g., a wireless router).

The laptop computer may use an OFDM modulated signal to transmit large amounts of digital data by splitting a radio frequency signal into multiple small sub-signals, which in turn are transmitted simultaneously at different frequencies. In particular, the laptop computer may use OFDM modulation to communicate over the WMAN 16. For example, the laptop computer may operate in accordance with the IEEE 802.16 family of standards (e.g., IEEE 802.16e) to provide for fixed, portable and/or mobile Broadband Wireless Access (BWA) to communicate with base stations 34, 36, 38 via one or more wireless links.

The WLAN 18 and WMAN 16 networks may be coupled to a common public or private network 12 such as the Internet, a telephone network, e.g., public switched telephone network (PSTN), a local area network (LAN), a cable network, and/or any other wired or wireless network via connection to Ethernet, digital subscriber line (DSL), telephone line, coaxial cable, and/or any wired or wireless connection, etc. For example, the WLAN 18 may be operatively coupled to the common public or private network 12 via the AP 28 and/or router 30. Alternatively, the WMAN 16 may be operatively coupled to the common public or private network 12 via the base stations 34, 36 or 38.

Note that the system 10 may comprise other wireless communication networks, for example, a wireless wide area network (WWAN). In this case, the laptop computer operates in accordance with other wireless communication protocols to support a WWAN. In particular, the wireless communication protocols may be based on analog, digital, and/or dual-mode communication system technologies such as Global System for Mobile Communications (GSM) technology, Wideband Code Division Multiple Access (WCDMA) technology, General Packet Radio Services (GPRS) technology, Enhanced Data for Global Evolution (EDGE) technology, Universal Mobile Telecommunications System (UMTS) technology, any other standards based on these technologies, variations and evolutions of these standards and/or other suitable wireless communication standards.

It is appreciated that the invention is not limited to use with the WPAN, WLAN and WMAN shown in the example network of FIG. 3, as the wireless communication system 10 may comprise other combinations of WPANs, WLANs, WMANs and/or WWANs. For example, the radio access communication system 10 may comprise network interface devices and peripherals, e.g., network interface cards (NICs), access points (APs), redistribution points, end points, gateways, bridges, hubs, etc. to implement a cellular telephone system, satellite system, personal communication system (PCS), two-way radio system, one-way pager system, two-way pager system, personal computer (PC) system, personal data assistant (PDA) system, personal computing accessory (PCA) system and/or any other suitable communication system.

Although some of the above examples are described above with respect to standards developed by ETSI and the IEEE, the mechanism of the present invention is applicable to numerous specifications and standards such as those developed by other special interest groups and/or standard development organizations, such as the Wireless Fidelity (WiFi) Alliance, Worldwide Interoperability for Microwave Access (WiMAX) Forum, Infrared Data Association (IrDA), Third Generation Partnership Project (3GPP), etc., and is not to be limited to the examples presented herein.

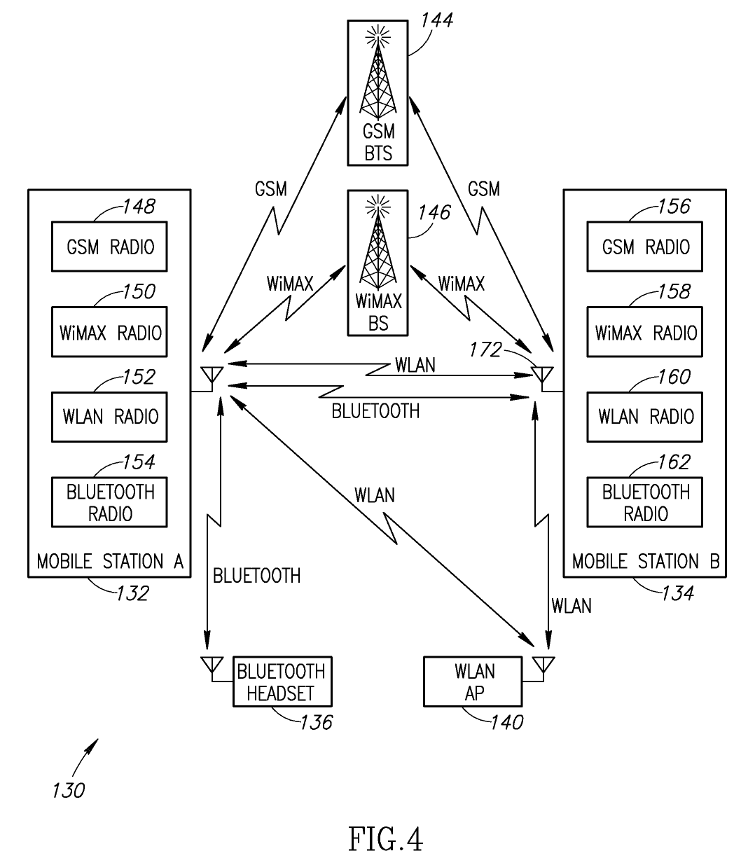

A diagram illustrating an example network incorporating WiMAX, WLAN, GSM and Bluetooth radios is shown in FIG. 4. The example radio access scenario, generally referenced 130, comprises mobile station A 132, mobile station B 134, GSM base transmit station (BTS) 144, WiMAX base station 146, WLAN 140 and Bluetooth headset 136. Mobile station A comprises GSM radio 148, WiMAX radio 150, WLAN radio 152 and Bluetooth radio 154. Similarly, mobile station B comprises GSM radio 156, WiMAX radio 158, WLAN radio 160 and Bluetooth radio 162.

Note that during operation, the GSM, WiMAX, WLAN and Bluetooth devices may all be communicating at the same time. Thus, the WLAN 152 and Bluetooth 154 radios in mobile station A may communicate with either the WLAN 160 and Bluetooth 162 radios in mobile station B, the Bluetooth headset 136 or WLAN AP 140. At the same time, the GSM and WiMAX radios 150, 152, 160, 162 communicate with the GSM BTS 144 WiMAX BS 146.

### Collocated Multiple Radio Communications Device

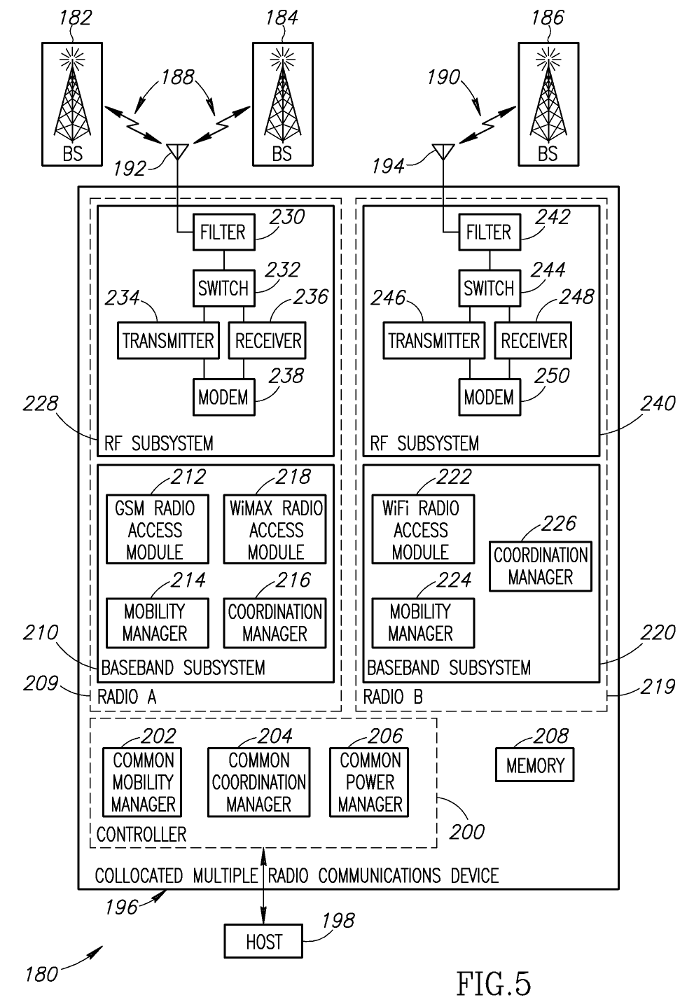

A diagram illustrating an example collocated multiple radio communications device in a coordination communication environment is shown in FIG. 5. The example communications environment comprises a collocated multiple radio communications device (e.g., mobile station) 196 in communication with a host 198 and a plurality of base stations 182, 184, 186. The communications device 196 comprises a plurality of radio access networks, for example radio access communication device (RACD) A (i.e. radio A) 209 and RACD B (i.e. radio B) 219, memory 208 and controller 200 which comprises common mobility manager 202, common coordination manager 204 and common power manager 206.

Radio A comprises RF subsystem 228 and baseband (i.e. PHY/MAC) subsystem 210. Baseband subsystem 210 comprises GSM radio access module 212, WiMAX radio access module 218, mobility manager 214 and coordination manager 216. RF subsystem 228 comprises modem 238, transmitter 234, receiver 236, switch 232 and filter 230 coupled to antenna 192.

Radio B comprises RF subsystem 240 and baseband subsystem 220. Baseband subsystem 220 comprises WiFi radio access module 222, mobility manager 224 and coordination manager 226. RF subsystem 240 comprises modem 250, transmitter 246, receiver 248, switch 244 and filter 242 coupled to antenna 194. Note that antennas 192, 194 may comprise a shared single antenna.

Note that RF subsystems and baseband subsystems can be either specific for each of the radio access communication systems or shared for several access communications system (i.e. via a shared communication block).

The communications device is capable of communicating with several different radio access communications systems, including a cellular communications network via base stations 182, 184 or 186. The communications device comprises separate communication blocks 209 (RACD A), 219 (RACD B) for each of the radio access communication systems with which it is capable of communicating. The communications device communicates to several radios access communication systems where, without the benefit of the present invention, collisions (due to full frequency overlap or operating in adjacent frequency or mere proximity) would otherwise occur between transmissions and/or reception of several of the radios access communication systems.

The radio interface 188 is connected to communication block 209 whose components are shared between the GSM and WiMAX access, including antenna 192 and RF subsystem 228. RF subsystem 240 is a dedicated RF subsystem for WiFi access. Note that the components of the RF subsystems may be implemented in multiple ways. For example, some or all of these functionalities may be integrated into a single component. Further, each RF subsystem may be implemented using dedicated hardware, such as power amplifiers, LNAs, coders, decoders, etc., needed for each particular radio access communications system.

The antenna and RF subsystems 228, 240 communicate with shared or dedicated baseband subsystems 210, 220, respectively. The baseband subsystems comprise local mobility management modules 214, 224 that receive information about the availability and strength of the signal received from the BSs 182, 184, 186. The local mobility manager modules 214, 224 can inter-communicate directly or to a common mobility manager module 202 that can either be located centrally in the controller 200 or in any of the baseband modules 210, 220. The common mobility manager module 202 can also be responsible for configuring the connection of one of the radio access modules to connect to the appropriate BS(s) 182, 184, 186 and to indicate to the local mobility managers 214, 224 the relevant parameters of the particular connection.

The TX/RX coordination mechanism of the invention can be implemented in the baseband processors as distributed coordination manager blocks 216, 226 or implemented in a centralized coordination unit 204. Each coordination unit is responsible for interacting with other system coordination units in the communications device and for coordinating allocations of availability and unavailability periods of transmission and reception between the different radio access communication subsystems to maximize performance. The system coordination units are coupled to the RF subsystems. The distributed (i.e. local) coordination managers communicate directly between themselves or through a common centralized coordination management module 204 that can be located in the controller 200 or any other baseband subsystem.

In addition, the centralized common coordination manager module 204 and/or the distributed local coordination controller modules can interface directly to a common power manager 206. The common power manager functions to configure and provide power to internal and external resources. The common power manager is adapted to receive power via an external power supply, battery and/or via the host 198. The common power manager can configure the relevant modules and subsystems (i.e. 228, 240, 210, 220, 200) to be in a low power state (e.g., lower power than in the active or wake state). In addition, the common power manager, upon reaching a predefined storage capacity in memory 208, commence a wake-up sequence, receive (e.g., via direct memory access, retrieval, etc.) a plurality of data frames from the memory and transmit them in a burst transmission. Data frames may be buffered by the baseband subsystems 210, 220 using the memory 208 or other memory device (not shown).

In one embodiment, the shared baseband subsystem 210 and/or the dedicated baseband subsystem 220 is further partitioned into upper MAC, lower MAC, and PHY modules, each comprising software (e.g., firmware) residing on respective processors executed by a suitable instruction execution system (i.e. processor). The functionality of the upper MAC, lower MAC, and PHY modules may comprise software stored in memory (e.g., memory 208) or other computer readable medium (e.g., optical, magnetic, semiconductor, etc.), and executed by the host processor 198 or other processor.

Alternatively, the PHY, upper and/or lower MAC module functionality may be implemented using a mix of software and hardware. In cases where the baseband subsystem is partitioned into lower MAC, upper MAC and PHY modules, the lower MAC module is usually responsible for radio interface access and controlling the availability and unavailability times in accordance with configurations received from the upper MAC. The upper MAC is operative to buffer (or equivalently, cache or queue) a plurality of data frames in memory during the unavailability periods.

Note that at any point in time, the GSM, WiMAX, WLAN radio access modules 212, 218, 222 can be in various internal states or modes, such as, but not limited to, shut down (off), Sleep/Idle/Scan (availability, unavailability periods), network discovery, network entry and active and are specific for each radio access technology. These states may be controlled by the local coordination manager 216, 226 or in conjunction with the common coordination manager 204.

When multiple radio access devices are collocated in a single communications device, the local coordination management modules or common coordination manager may limit network entry to one radio access module at a time.

Further, the radio access modules 212, 218, 222 can transition to any other states independently to avoid interference by inhibiting complete or partial overlapping transmission or reception. Regardless of the state, when transmitting and/or receiving, the sub-client module may require use of shared components (antenna, RF subsystem, etc.).

The memory 208 may comprise any suitable memory device such as static or dynamic RAM, nonvolatile memory such as FLASH, EEPROM, EPROM, PROM, ROM or any other type of memory. Note that in one embodiment, the TX/RX coordination mechanism of the invention is implemented as firmware/software that resides in memory and executed in the communication units 210, 219, baseband processor or other controller device or is implemented in hardware in the PHY or MAC layers or a combination thereof. Alternatively, the mechanism may be implemented in the host 198 or a combination of the host and communications units or may be implemented in the controller 200.

In some embodiments, the communications device 196 can be configured (e.g., preprogrammed, operator configured or user interface configured) to have a policy or set of operational rules for coordinating and/or synchronizing (coexistence), mobility, power management and/or any other functionality that would be within the scope of MAC functionality.

### Collocated Coordination System

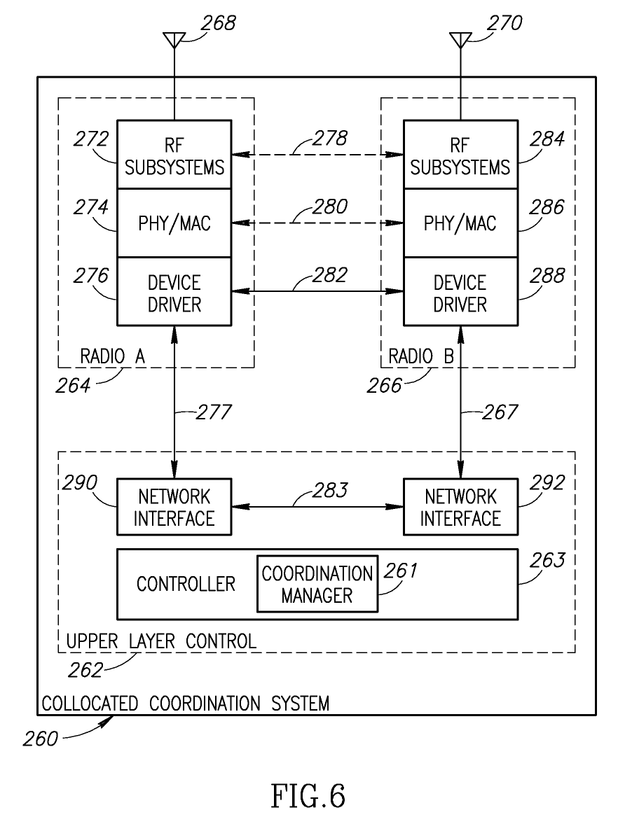

A diagram illustrating an example collocated coordination system of the present invention is shown in FIG. 6. The system, generally referenced 260, comprises two radio access communication devices (RACD) 264 (radio A) and 266 (radio B) and upper layer control unit 262. RACD A 264 comprises device driver 276. PHY/MAC 274 and RF subsystems 272 coupled to antenna 268. Similarly, RACD B 266 comprises device driver 288. PHY/MAC 286 and RF subsystems 284 coupled to antenna 270. Upper layer control unit 262 comprises a controller 263 incorporating coordination manager 261 for providing coordination/coexistence support and two radio access network interface (RANI) blocks 290, 292. Note that depending on the implementation, the collocated system 260 can be integrated into a single platform such as mobile station A 132 (FIG. 4). RACDs A and B may be implemented, for example, as separate integrated circuits, collocated on the same die or in the same SoC.

In accordance with the invention, the RACDs A and B interact with each other via software (and/or firmware) and hardware interfaces 278, 280, 282. At the protocol level, interface 282 of the collocated coordination system 260, the RF subsystem 272, PHY/MAC 274 and device driver 276 of RACD A is in communication with RACD B and device deriver 288 to exchange RACD configuration information. The hardware interface between RF subsystems 272, 284; PHY/MAC modules 274, 286; device drivers 276, 288 and RANIs 290, 292 comprise one or more wired links, 278, 280, 282, 283, respectively, which function to communicate information between RACDs A and B. Note that each wired link 278, 280, 282, 283 may comprise unidirectional or bidirectional links and are operative to transmit messages, indications, priority and any other type of information. Dashed links 278, 280 indicate that these links comprise logical links rather than direct physical communication links (solid links), in accordance with the particular implementation. In addition, the communications links may be realized by mechanisms other than wires, such as shared memory or other software based communication mechanisms.

Note also that RACDs A and B may communication with each other via a single bidirectional wired link rather than via two separate, unidirectional or bidirectional wired links. Thus, priority signals from either RACD A or B may be transmitted on the same wired link.

In this example embodiment, RACD A provides communication services associated with a radio access communication network (e.g., GSM, WiMAX) 209 (FIG. 5) while RACD B provides communication services associated with a wireless communication network (e.g., WLAN) 219 (FIG. 5). It is appreciated that other configurations and combinations of radio access networks maybe used with the present invention. Although the RACDs A and B are associated with radio access communication networks based on different wireless technologies, they can operate within an identical, adjacent or overlapping frequency range or any other frequency range combination that may cause interference due to the proximity of RACD A to that of RACD B.

In accordance with the invention, RACDs A and B operate concurrently (i.e. simultaneously) by coordinating transmission and reception allocations of availability and unavailability periods to achieve a level of coexistence. Considering the example of FIG. 3, the collocated coordination system of FIGS. 4 and 5 may be implemented in the laptop computer 22 (FIG. 3). In one example, RACD A communicates based on WLAN technology and RACD B communicates based on GSM and/or WiMAX technology. In particular, the laptop computer uses RACD A to communicate with other WLAN devices shown in FIG. 3 such as printer 24, handheld computer 26, smartphone 32 and access point (AP) 28. The laptop computer uses RACD B to communicate with any of the WMAN devices such as base stations 34, 36, 38. It is appreciated that although the above examples are described with respect to GSM, WiMAX and WLAN technologies, RACDs A and B may be based on other radio access technologies without departing from the scope of the invention.

RACDs A and B exchange configuration information with each other. In particular, the coordination managers 216, 226 (for the distributed scheme of FIG. 5) exchange configuration information with each other via the common coordination manager 204 in controller 200. The device drivers 276, 288 (for the centralized coordination scheme of FIG. 6) exchange configuration information with each other via RACD network interfaces 290, 292, respectively. In both cases, the configuration information of each radio access communication device indicates the manner in which the radio access communication device communicates via a radio access link in the respective wireless communication network.

For example, coordination managers 216, 226 and device drivers 276, 288 exchange information indicating the channels used by and/or assigned to RACDs A and B, respectively. In addition to channel information, the coordination managers or device drivers also exchange information indicating the bandwidth, transmission power, front-end filter, reception sensitivity, antenna isolation and/or any other pertinent information associated with RACDs A and B.

Based on the configuration information, RACDs A and B operate in a coordination manner. In particular, each coordination manager is operative to determine whether to adjust the configuration of RF and baseband subsystems in its respective radio access in order to optimize and/or enable communications via the radio access links.

### TX/RX Allocation Detection, Coordination and Synchronization Mechanism

It is noted that modern radio access networks like WiMAX, UMTS, CDMA2000 and LTE are managed networks with limited bandwidth. The TX/RX allocation detection, coordination and synchronization mechanism of the present invention (such as to achieve coexistence) attempts to maximize the effectiveness of each individual radio access network use when operating in tandem with other collocated access networks. Thus, the TX/RX coordination mechanism allows radio access transceivers to receive and transmit on all availability opportunities granted and/or assigned to it in accordance with a predefined Quality of Service (QoS) aware mechanism or air link conditions, as described in more detail infra.

It is important to note that conflicts may arise in some scenarios between the goal of providing some required multi-radio access networks services and enabling full utilization of the collocated access network. The coordination mechanism of the present invention attempts to maintain a “zero waste” policy of maximizing bandwidth utilization and in the few cases where this is not possible provides a tradeoff between radio access network optimization and degradation of service. Radio access optimization relates to bandwidth utilization, required QoS, QoE, MS power consumption, minimal link condition, PER, BLER, BER or any other link level or connection level optimization target.

The coordination mechanism of the present invention utilizes multiple algorithms depending on the capabilities of the particular radio access module, network support capability and the Sleep, Scan and or Idle (power save) mode support of the radio access network. In the example embodiment presented herein, the coordination mechanism is implemented in the baseband processors of the GSM, WiMAX and WLAN radio modules.

The WiMAX transceiver time base is synchronized to the GSM allocated time slot using Sleep, Scan and/or Idle (power save) mode support. The WLAN transceiver time base is synchronized to both GSM and WiMAX time slots (i.e. frames). The synchronization can be performing independently for transmission and reception. Reception, however, considers the transmission pattern.

For purposes of the example embodiment presented herein, WLAN transmissions are preempted whenever the WiMAX radio is operating in either receive or transmit. The next unavailability period can be predicted or sensed by the WLAN PHYAMAC coordination manager 226 (FIG. 5) and/or common coordination controller 204. Note that there may be cases where the WLAN radio has high priority, e.g., transmission/reception of Beacon signals, the radio is currently connected to the WLAN network with high signal strength eliminating the need for service continuity, etc.

WiMAX transmission or reception time slots (i.e. frames) are initially coordinated and synchronized based on previous Sleep, Scan and/or Idle (power save) mode coordination such that they either do not overlap or partly overlap GSM listen or transmission windows. In the case of a predefined or unpredicted conflict, a prioritization mechanism is used. The prioritization mechanism considers radio access PHY level performance and methods (e.g., HARQ) and MAC level (ARQ) retransmission capabilities as well as Quality of Service (QoS) requirements. In the case of a conflict, the PHY/MAC coordination manager and/or common coordination controller initiates modification, renegotiation, assignment, reassignment or modification of flexible irregular transmission and reception availability patterns. Multi-radio access synchronization can make use of a common clock base and time slot (i.e. frames) related indications signal (e.g., boundaries, start, stop, symbol boundaries). In the case a common clock base is used for several of the radios, multiple PHY level implications can be used such as the capability to perform frequency and time synchronization and corrections based on indicated clock offset and drift from the radio access specific clock. In some cases, simultaneous transmissions, receptions or a combination thereof may be allowed.

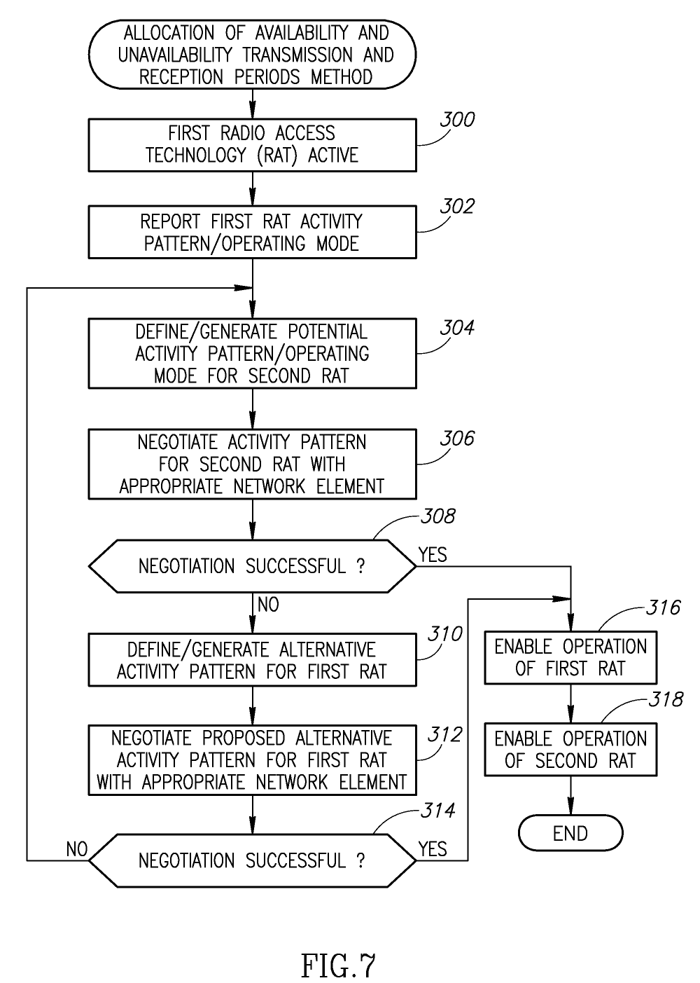

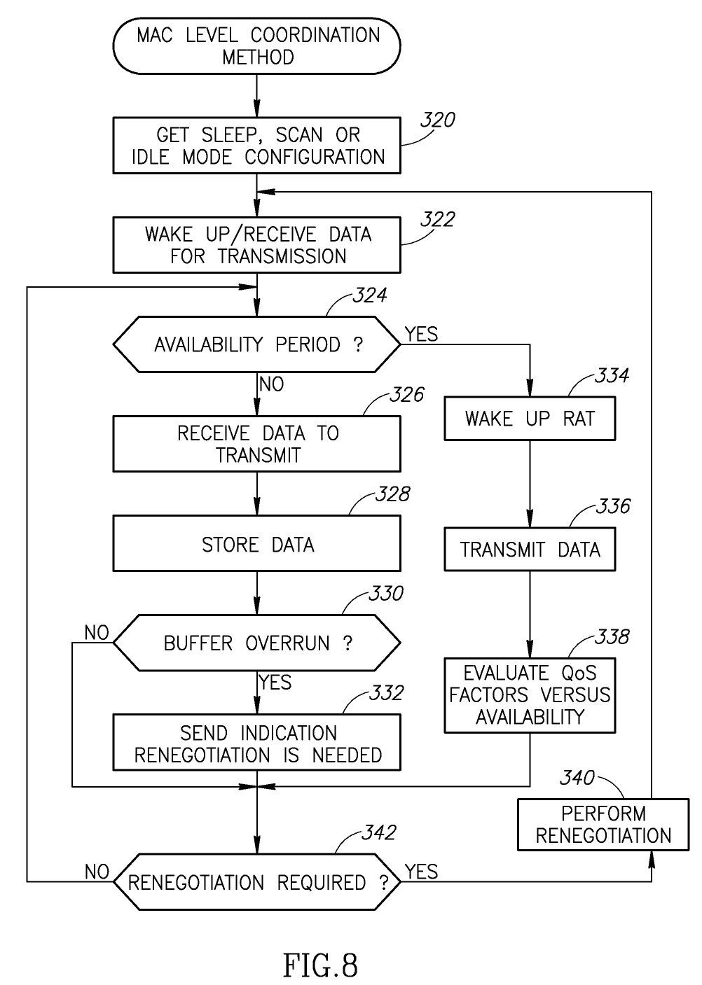

The operation of a coordination unit in a multi radio access capable communication device and a MAC level radio access coordination unit (FIG. 6) will now be described in more detail. A flow diagram illustrating the method for coordinating the allocation of availability and unavailability transmission and reception periods of the present invention is shown in FIG. 7. A flow diagram illustrating the MAC level coordination method of the present invention is shown in FIG. 8.

The methods of FIGS. 7 and 8 illustrate the operation of a multi-radio access coordination unit. The radio access units are capable of conveying their transmission and reception allocations to the coordination manager (204 in FIG. 5; 261 in FIG. 6). Allocations may be conveyed by any suitable means such as message passing, wire based transfer, dedicated signal or information path or any other suitable communication process. Alternatively, the radio access units or the coordination manager may be able to detect transmission and receptions of other radio access units by monitoring (1) RF activity, and/or (2) external or internal signaling between or within MS components such as transceiver control signals, RF detector, battery monitor, or by any other suitable means. In a synchronization procedure, the transmission or reception information detected is further analyzed by the centralized or distributed coordination manager to gain knowledge of specific activities of each radio access unit. Note that an understanding of the underlying protocol(s) including specific messages in use is required to perform synchronization. For example, synchronization can be used to detect information on the relative importance of the data traffic, e.g., voice service, mission critical service, best effort data service, etc.).

The coordination manager (203 in FIG. 5; 261 in FIG. 6) then sets the specific radio access transmission and reception opportunities using a coordinated synchronized and negotiated allocation mechanism and by interaction and coordination with other radio access. The transmission and reception coordinator specifies specific times that a particular radio access in the MS can either allocate to or prohibit from transmitting or receiving packets. The MS may receive corrupted information or not be allowed to transmit outside of the specific allocated times that were coordinated and enforced by the central (204 in FIG. 5; 261 in FIG. 6) and/or distributed (216, 226 in FIG. 5) coordination controllers. Once the MS specific radio access coordination controller receives the reserved transmit/receive allocations, it reports it to and coordinates it with (1) other specific radio access coordination controllers and/or (2) the central radio access coordination controller.

Note that alternatively, rather than the radio access units indicating their TX/RX allocations to the coordination manager, the radio access units detect the transmission and reception allocations of other radio access units, as described supra. This is performed, for example, utilizing an RF or signal sniffer monitor or by access to external or internal signaling between or within MS components such as transceiver control signals, RF detector, battery monitor or by use of any other suitable means.

Note also that in one example embodiment of the present invention, the lower priority radio access coordination controller does not need to perform transmission coordination but rather uses the gaps between higher priority radio access transmit/receive allocations to carry out its own transmit/receive allocations of availability periods. In other embodiments of the present invention, the lower priority radio access coordination controller sends feedback to the high priority radio access so the high priority radio access may adapt its activity pattern accordingly. Note, however, that if the lower priority radio is WiMAX, for example, it will need to coordinate according to the available gaps.

According to a preferred embodiment of the present invention, specific radio access packet traffic is given a priority level which can be used to help reduce the probability of collisions of higher priority packets. For example, the local coordination controller, as well as the central coordination controller can be assigned a high priority to specific packet traffic or transmit/receive reservation. In addition, coordination controller endpoint traffic is also marked as high priority. For example, the prioritization can be based on either the applications using the endpoints or on one or more characteristics of the endpoints. The transmit/receive reservation allocations of availability periods includes the priority information.

The flow diagrams of FIGS. 7 and 8 illustrate the high-level views of the operations of the coordination units within communications blocks in a MS, wherein the MS has established connections to a plurality of radio access communications networks. Preferably, one of the collocated radio access communications networks transmits and receives only within allocated times, wherein the allocations are performed by radio access specific controllers (e.g., a base station or host). With one of the collocated radio access communications networks communicating only during its allocated times, the other communications network is free to use any of the unallocated times to communicate.

The flow diagrams of FIGS. 7 and 8 also illustrate the operation of a coordination unit of an MS for a first collocated radio access communications network (e.g., RACD A), wherein the first collocated radio access communications network communicates only during allocated times. In this case, different priority methodologies (i.e. criteria) may be used to select the first (i.e. high priority) network, such as cost of data bandwidth, QoS, licensed versus unlicensed spectrum, flexibility of MAC layer, etc.

It is noted that the method of FIGS. 7 and 8 may be performed in a communications device having centralized or decentralized coordination management or in a hybrid combination that includes elements of both centralized and decentralized operation.

With reference to FIG. 7, operation begins with the first radio access technology (RAT) (i.e. RACD A) becoming active (step 300). The coordination unit of the first collocated radio access communications network receives a transmission/reception allocation reported from a controller of the first collocated radio access communications network (step 302). The transmission/reception allocated activity pattern (i.e. availability and unavailability periods) and/or operating mode (all referred to as the ‘activity and/or inactivity pattern’) can then be reported/provided to the coordination units of other collocated radio access communication networks (i.e. other RACDs). Packet traffic from the first wireless communications network can then be received and transmitted as allocated. Note that in the case of one or more of the collocated radio access communications networks providing circuit switched (CS) service, the CS service can be viewed as a packet service with a CS QoS requirement which may be assigned a high priority.

The coordination unit of the second collocated radio access communications network (RACD B) receives the allocations of availability periods of transmissions and receptions from the coordination unit of the first collocated radio access communications network. At some point, the second RAT desires to activate its radio access (i.e. either transmission or reception). The coordination unit in the second RAT (e.g., RACD B), having knowledge of the existence of and activity pattern of the first RAT, defines/generates a potential activity pattern/operating mode for the second RAT (step 304). Based on the activity pattern, the operation of the second (or other) wireless communications network in the MS can be determined. For example, if the traffic is heavy and the already allocated availability periods do not allow for the operation of the second RAT, then the MS is placed in an operating mode that will reduce its own traffic. Alternatively, if the allocated traffic is light, then the MS is placed in an operating mode that can maximize data throughput and flexibility.

The activity pattern may comprise any pertinent information related to the operation of the radio access. It may comprise, for example, a table that includes the possible states and current state for the RAT, associated priority information (e.g., voice, signaling information, IP connections, or other information relating to criticality of the traffic, etc.), desired bandwidth, quality of service, etc. The second RAT takes any or all combination of these inputs into consideration in generating the potential activity pattern.

The transmission and reception of information from the second collocated radio access communications network is performed based on the reserved allocation provided by the coordination controller of the first collocated radio access communications network. If there is a need to transmit or receive a packet that would result in a collision, then additional processing is performed to reduce (or eliminate) the probability of collision or reduce the effects of the collision. For example, the packet is split into a plurality of smaller packets and transmitted using frequencies that would not result in a collision. Alternatively, the packet is sent at a later time to avoid a collision.

Once the potential activity pattern for the second RAT is determined, it is negotiated with the appropriate network element (step 306). In the case of a cellular radio access (e.g., GSM, WiMAX, etc., the second RAT negotiates the activity pattern from the base station the communications device is connected to. It is noted that the negotiation process between the RAT in the mobile station and the base station is well know in the wireless arts. Normally, the capabilities of a mobile station are made available to a radio access base station (or other network element). Mobile stations operating in the system negotiate a certain Quality of Service (QoS) with the system before they are granted a dedicated data channel. The negotiation process may differ from one particular radio access system to another. Typically, however, most service request negotiations include conveying information such as data rates, link quality indication, spreading factors, mean packet delay requirements, packet loss, buffers sizes, requested sleep patterns, etc. The information will typically vary according to the particular RAT. The radio access base station determines whether the requested quality of service can be supported by the mobile station in its current cell. These capabilities are taken into account in negotiating a quality of service and various parameters in configuring packet traffic flow between the mobile station and the base station.

Note also that transmission/reception opportunities may be allocated without negotiating, as negotiation is not always necessary or feasible. For example, in the case of opportunistic wireless networking, negotiation is neither needed nor performed. As a further example consider the case where at least one of the radio access networks does not easily support negotiating availability patterns; e.g., in the case of GSM voice service, there are no inherent mechanisms supporting a request to hand over from one time-slot allocation to another, nor between full rate voice codec and half rate voice codec usage.

In an alternative embodiment, the potential activity pattern for the second RAT is determined but rather than negotiate an activity pattern with the second RAT to meet the proposed second activity pattern, an activity pattern is negotiated with the first RAT network element to meet the proposed first activity pattern. For example, consider the case of the second RAT comprising opportunistic wireless networking or GSM voice service where negotiation is not performed, as described supra. In this case, the second activity pattern is not negotiated. Rather, the first activity pattern may need to be negotiated with the first RAT.

If the negotiation is successful (step 308), operation of the first RAT is enabled (step 316) as well as operation of the second RAT (step 318). If the negotiation between the mobile station and the base station failed (step 308), than an alternative activity for the first RAT is defined/generated (step 310). Thus, the roles of the first and second RAT are essentially reversed. In other words, the potential activity pattern for the second RAT previously generated (step 304) is accepted as if received by the first RAT and a new alternative activity pattern for the first RAT is generated.

The proposed alternative activity pattern for the first RAT is then negotiated with the appropriate network element (e.g., first RAT base station). If negotiation was successful (step 314), the first and second RATs are enabled (steps 316, 318). If the negotiation was not successful (step 314), a new alternative proposed activity pattern for the second RAT is generated (step 304) and the process repeats.

In order to prevent continuous looping in the event there is no activity pattern for the first and second RATs that can be successfully negotiated for the corresponding base stations, the method may determine in steps 304/306 to allow one RAT to conflict/interfere with another RAT. Various factors are taken into account including, for example, the specific need of one RAT in terms of priority, necessity to transmit at a specific time, or any other factors to be considered.

The MAC level coordination method using Sleep, Scan or Idle modes shown in FIG. 8 will now be described in more detail. With reference to FIG. 8, this method is performed as an ongoing process by the baseband subsystems 210, 220 and the coordination managers 216, 226 and/or the common coordination manager 204 associated with the relevant radio access modules 212, 218, 222 during steady state operation of the MS. The method begins by obtaining the current sleep, scan or idle mode configuration (step 320). Note that the method is performed during the unavailability period for the relevant radio access network interface 188, 190 (FIG. 5). At this time, operation of the first, second, etc. RATs are enabled (steps 316, 318 in FIG. 7), each with its associated activity pattern, and either (1) the radio access wakes up because the RAT now has an opportunity to transmit or (2) the radio access receives a packet (frame) of information to transmit from the upper layers (step 322). When the MAC is active, the radio access will either (1) be in an availability period for potential transmission/reception or (2) be requested to transmit data from upper layers.

If the radio access is in an availability period (i.e. ready for potential TX/RX) (step 324), then the radio access (i.e. RAT) is woken up (step 334) and transmission of data (if needed) is performed (step 336). One or more factors versus availability is then evaluated (step 338). It is during this step that changes to the availability of the radio access may be made depending on the current coordination or coexistence constraints. For example, the coordination constraints can be relaxed if the radio access does not fully utilize its availability period (i.e. the RAT does not always receive or receive). This allows more time (i.e. slots, frames, etc.) for other RATs. In this case, the availability pattern is renegotiated such that future availability periods are shorter leaving more time for other RATs (steps 342, 340). Thus, the method attempts to optimize the availability patterns to suit actual usage by the RAT (i.e. the amount of time reserved for that particular RAT versus what is actually needed).

The factors evaluated in step 338 can include any or all of a variety of factors. Examples of factors used to measure against availability include, but are not limited to Quality of Service (QoS); RF parameters including RF coupling, TX power, RX immunity (e.g., selectivity or other channel rejection); estimated channel characteristics including CQI, CINR mean, CINR standard deviation, RSSI mean, RSSI standard deviation; and link quality including Traffic Peak Rate/PIR with the time base for calculation, traffic rate deviation, latency, jitter, loss ratio, CIR fulfillment, voice quality, grade of service indications, BER, PER, BLER and network Key Performance Indicators (KPI).

On the other hand, if the usage of the RAT exceeds its current availability pattern, the RAT can renegotiate with the base station to arrange for future availability patterns to provide the opportunity to transmit more data (if possible), leaving less time for other RATs.

In one embodiment, the QoS evaluation is performed at each availability period. If the RAT is able to transmit all the information it has buffered, than no change needs to be made. If, however, there is no information to transmit, the RAT may renegotiate the availability period to give other RATs additional time.

If the RAT is not in an availability period and. the RAT is awake and received data from the upper payers (step 324), then data (e.g., frames) for transmission is received from the host processor 198 (FIG. 5) (step 326) and stored in memory 208 (step 328). It is then determined whether the currently stored data (frames) exceed the predefined storage capacity of the memory, i.e. a buffer overrun has occurred (step 330). If the currently stored frames do not exceed a predefined storage capacity, then it is determined whether renegotiation with the base station is required (step 342). The decision whether to renegotiate is determined based on QoS. An examination of the status of the buffer, for example, can indicate whether any changes to the activity pattern need to be made. The RAT may be available too much or too little for the data to be transmitted. In this case, the RAT can renegotiate its availability pattern to further optimize operation of the communications device. In other words, the method takes into account QoS constraints and actual service needs and in response, modify the coordination or activity patterns on an ongoing basis to optimize device operation.

Thus, a buffer overrun will likely trigger an indication that renegotiation is required (step 332). If it is determined that renegotiation is required (step 342), then the relevant radio access modules commence a transition to wake-up mode and a renegotiation with the base station is performed (step 340).

It is noted that although the loop is updated each and every time the RAT wakes up, the renegotiation is not necessarily changed each and every time the RAT wakes up. The method of FIG. 8 is effectively an optimization process that is performed between the signaling overhead. The method examines how much the real quality of service needs of the radio service have changed versus whether the current period is just weak or strong period.

In an alternative embodiment, the MAC level coordination management method can be generalized wherein the method begins with an unavailability period during which a plurality of frames are queued for transmission until a predefined event/trigger is set on which the coordination controller is triggered to commence transmission in a preferably burst manner.

Note that an implementation of the coordination mechanism can use all or a combination of the above methods and techniques wherein a specific method, technique or algorithm may be used in accordance with the supported features and traffic types of the particular system and collocated radio access capability, QoS and activity.

In one embodiment of the invention, if it is detected that packets from a first RAT would potentially collide (i.e. overlap) with packets from other RATs, the coordination manager is operative to simply skip (i.e. not transmit) the packets that would otherwise cause the collision. The skipping of the packet transmission may involve aborting the transmission and then requesting reallocations of the transmission and/or allocated availability and/or unavailability periods.

### Coordination Example for GSM, WiMAX and WLAN RATs

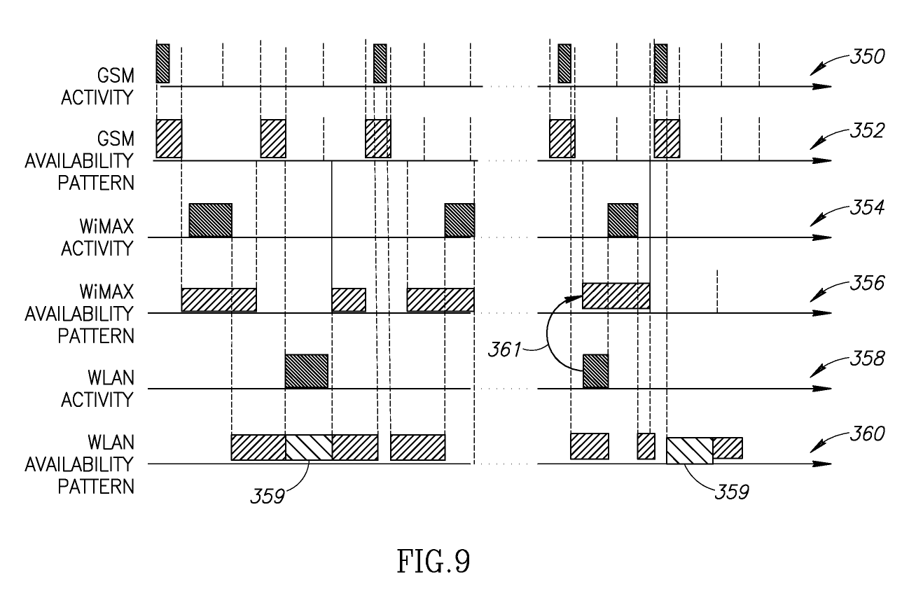

Examples of coordination (more specifically, coexistence in this case) scenarios for (1) GSM and WiMAX RATs and for (2) GSM, WiMAX and WLAN RATs will be presented. A timing diagram illustrating a coordination example of non-limiting burst reception and transmissions availability over time for several radio accesses (e.g., GSM, WiMAX and WLAN) using distributed coordination by the MS is shown in FIG. 9.

The WiMAX base station (BS), to which the WiMAX radio access unit (i.e. MS) communicates, conveys a transmission and reception allocation to the MS. The allocation of availability and/or unavailability periods is conveyed, for example, in a Media Access Protocol (MAP) message at the beginning of each WiMAX frame. The transmission and reception allocation specifies the specific times that the MS can use to transmit or receive packets. This predefined allocation can be negotiated and modified by the use of WiMAX Sleep, Scan and/or Idle modes. The MS cannot receive or transmit outside of the predefined specified times. In accordance with the invention, once the MS receives the transmit/receive allocations, the WiMAX radio access coordination manager provides the transmit/receive reservation allocations to other radio access coordination controllers or to a central coordination manager to perform coordination.

When the coordination is complete (which may take several iterations) the MS can then transmit and receive message bursts (or simply, messages) in the form of WiMAX packets as allocated. If the requested WiMAX traffic is too intensive, it may be possible to throttle down the WiMAX traffic or renegotiate a new availability and/or unavailability pattern to help improve the performance of the other radio access networks, as described in connection with the method of FIG. 8.

At the GSM radio access, the GSM coordination controller, after receiving the transmit/receive reservation allocations from the WiMAX coordination manager or from a central coordination manager determines if any GSM traffic will collide (i.e. overlap) with WiMAX traffic. Potential for a collision exists since both WiMAX and GSM use allocated transmissions and receptions. If there are no collisions, then the transmission and reception of the GSM slots can occur as allocated. If some of the GSM slots will collide, however, then processing of the GSM slots that will collide with WiMAX traffic must occur prior to their transmission. In the example above, it is implied that the WiMAX traffic is assigned higher priority than that of the GSM traffic. Alternatively, in other cases (1) the GSM traffic may be assigned higher priority or (2) different GSM and/or WiMAX messages will be assigned higher priority.

According to a preferred embodiment of the present invention, the MS operates in one of the power save modes of each of the radio access networks in such a way that the radio access coordination management blocks reserve a transmission and reception allocations of availability periods for each of the radio access networks in accordance with a set of predefined priority rules. Once the availability allocation of the first radio access network is defined by the radio access coordination manager(s), any unreserved time can be used for other radio access unit traffic. Note that transmission and reception opportunities can be computed based on the reserved allocations provided by the MS radio access power save mode capabilities.

A GSM, WiMAX and WLAN environment will now be considered. In GSM and WiMAX, an MS can transmit and receive only when permitted to do so in accordance with a set allocation that is provided by the GSM and/or WiMAX BSs. In addition, since GSM and WiMAX are typically a ‘pay for use’ communications system over licensed spectrum and since WLAN systems on the other hand are typically not ‘for pay’ systems using unlicensed spectrum, GSM and WiMAX communications should be given priority over WLAN. Since GSM and WiMAX transmissions and receptions can occur only when allocated GSM and WiMAX unallocated times can be used for WLAN packet traffic. Note that in this case there is no need for allocation negotiation for WLAN.

According to the GSM and/or WiMAX coordination manager or central coordination manager reporting (i.e. reserved allocations of availability periods), certain times cannot be used to transmit and receive WLAN packets, as these times are reserved for transmitting and receiving GSM and/or WiMAX packets. Any remaining time, however, can be used by the MS to transmit and receive WLAN packets. The WLAN coordination manager may negotiate with other radio access coordination managers regarding transmission times for WLAN in case there is need to transmit or receive information over a duration that is too long to fit within the time between GSM and/or WiMAX packets.

For WLAN reception purposes, the WLAN coordination manager tracks the response of the AP to poll packets or Unscheduled Power Save Delivery (UPSD) packets. Based on tracking information of the AP's response times, the WLAN coordination manager sends poll or UPSD packets to the AP only if the probability of the AP responding with a downstream packet within the transmit or receive opportunities is within a predetermined threshold. If the probability meets or exceeds the predetermined threshold, then the poll or UPSD packet is sent to the AP as well as any other transmissions that can be completed within the transmit or receive opportunities.

According to a preferred embodiment of the present invention, the MS operates in one of two GSM and/or WiMAX modes: (1) an active mode where the MS can actively receive and/or transmit information over the GSM and/or WiMAX radio access networks and (2) a power savings mode that comprises active and inactive periods where the MS can place its GSM and/or WiMAX circuitry or other MS element into a low power mode for a specified amount of time.

With reference to FIG. 9, the timing diagram illustrates the availability over time of an MS, wherein the MS is actively maintaining a connection with GSM, WiMAX and WLAN communications networks. In such a situation, transmission collisions can occur if the GSM and/or WiMAX and/or WLAN communications network transmit or receive at the same time.

GSM, WiMAX and WLAN activity is indicated in timing traces 350, 354, 358, respectively. The solid portions in the activity timing traces 350, 354, 358 indicating active TX/RX periods. Availability patterns corresponding to GSM and WiMAX and operation opportunities corresponding to WLAN are indicated in timing traces 352, 356, 360, respectively. The grayed portions in the availability/operation opportunity timing traces 352, 356, 360 indicating available periods where transmission/reception is expected.

More specifically, first trace 350 represents allocated transmission and reception times for the MS over the GSM interface, based on allocated availability pattern 352 sent by the GSM network. Trace 354 represents the allocated transmission and reception times for the MS regarding the WiMAX network based on MAP messages sent at the beginning of each and every WiMAX frame, which are in turn based on the allocated availability pattern 356. Trace 358 represents the WLAN transmission and trace 360 represents the valid WLAN transmission opportunities.

As described supra, both GSM and WiMAX radio access can transmit and receive only when permitted to do so according to an allocated set of availability periods provided by a respective Base Station Controller (BSC) or base station (BS). In the example scenario of FIG. 9, GSM was arbitrarily given priority over WiMAX communications. The order the timing traces are presented is related to the radio access priority. Thus, GSM has the highest priority while WLAN has the lowest.

An example of a potential collision is indicted by arrow 361 wherein WLAN transmission/reception activity potentially collides with WiMAX transmission/reception activity (grayed portion of WiMAX availability pattern). Further, the crosshatched portions 357, 359 of the WLAN operation opportunity timing indicate a ‘safe zone’ in which the WLAN radio access can operate as it does not interfere with GSM or WiMAX transmission/reception activity or availability patterns.

Since GSM, WiMAX and WLAN units can only receive and transmit messages over the air in accordance with allocations of availability periods that are dictated by the GSM, WiMAX and WLAN network elements (BSC, BS and AP), it may be possible to allocate, using the mechanism of the present invention, the availability patterns (i.e. availability periods) for each radio access technology in such a way as to ensure coexistence.

Since the MS will not transmit or receive any GSM signals outside of the allocated times, the unallocated times can be used for WiMAX and WLAN transmissions and receptions. Although WiMAX transmissions and receptions are also allocated, collisions can still occur if an allocated GSM and WiMAX transmission or reception occurs within a reserved time. The built-in retry mechanism that is a part of the GSM and WiMAX communications protocol, however, can help to keep the data throughput loss to a minimum.

The MS alternating between GSM, WiMAX and WLAN radio access can permit the sharing of certain hardware. For example, since in this case the MS can only be in one radio access at a time, only a single multimode transceiver (i.e. transmitter and receiver) and antenna are needed. In addition, the GSM, WiMAX and WLAN coordination managers along with their respective MAC controllers can be implemented in a single unit. It is noted that in some cases, there are some combinations of RF subsystems whose activity patterns may be permitted to collide (i.e. overlap) as long as it would not raise any coordination (coexistence) issues. For example, activity patterns are allowed to collide when the respective frequency bands are sufficiently separated that no interference would be generated.

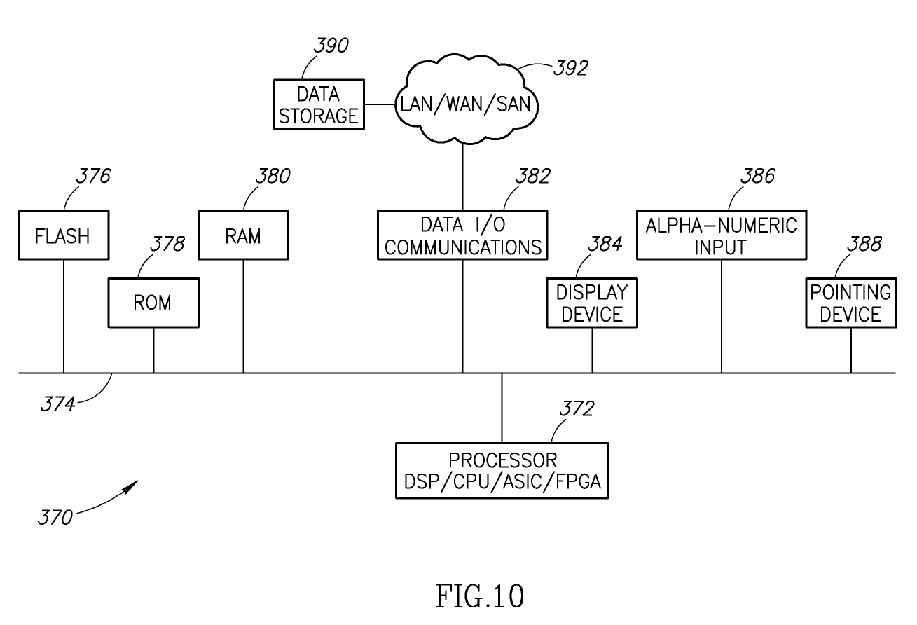

A block diagram illustrating an example computer processing system adapted to implement the transmission/reception coordination mechanism of the present invention is shown in FIG. 10. The computer system, generally referenced 370, comprises a processor 372 which may comprise a digital signal processor (DSP), central processing unit (CPU), microcontroller, microprocessor, microcomputer, ASIC or FPGA core. The system also comprises static read only memory 378 and dynamic main memory 380 all in communication with the processor. The processor is also in communication, via bus 374, with a number of peripheral devices that are also included in the computer system. Peripheral devices coupled to the bus include a display device 384 (e.g., monitor), alpha-numeric input device 386 (e.g., keyboard) and pointing device 388 (e.g., mouse, tablet, etc.)

The computer system is connected to one or more external networks such as either a LAN, WAN or SAN 392 via communication lines connected to the system via data I/O communications interface 382 (e.g., network interface card or NIC). The network adapters 382 coupled to the system enable the data processing system to become coupled to other data processing systems or remote printers or storage devices through intervening private or public networks. Modems, cable modem and Ethernet cards are just a few of the currently available types of network adapters. The system also comprises magnetic or semiconductor based storage device 390 for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the transmission/reception coordination mechanism of the present invention is adapted to reside on a computer readable medium, such as a magnetic disk within a disk drive unit. Alternatively, the computer readable medium may comprise a floppy disk, removable hard disk, Flash memory 376, EEROM based memory, solid state memory, bubble memory storage, ROM storage, distribution media, intermediate storage media, execution memory of a computer, and any other medium or device capable of storing for later reading by a computer a computer program implementing the method of this invention. The software adapted to implement the threshold driven log synchronization method of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the transmission/reception coordination mechanism of the present invention, and to the extent that a particular system configuration is capable of implementing the system and methods of this invention, it is equivalent to the representative digital computer system of FIG. 10 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of transmission and reception coordination for use with a plurality of radio access technologies (RATs) including a first RAT with a first activity pattern, the method comprising the steps of:
determining at least one candidate second activity pattern for transmission and/or reception opportunities/avoidance to a second RAT based on said first activity pattern; and
enabling operation of said second RAT in accordance with said candidate second activity pattern.

2. The method according to claim 1, wherein said second activity pattern is determined based on said detection of said first activity pattern.

3. The method according to claim 1, wherein said second activity pattern is determined based on conveyance of said first activity pattern by said first RAT.

4. The method according to claim 1, wherein said second activity pattern is determined based on synchronization to said first activity pattern.

5. The method according to claim 1, further comprising the steps of:
first negotiating said candidate second activity pattern with a network element of said second RAT; and
if said first negotiation is successful, enabling operation of said second RAT in accordance with said second activity pattern.

6. The method according to claim 5, further comprising the steps of:
if said first negotiation is unsuccessful, determining a candidate first activity pattern for said first RAT based on said candidate second activity pattern for said second RAT; and
enabling operation of said first RAT in accordance with said candidate first activity pattern and said second RAT in accordance with said candidate second activity pattern.

7. The method according to claim 6, further comprising the steps of:
second negotiating said candidate first activity pattern with a network element of said first RAT; and
if said second negotiation is successful, enabling operation of said first RAT in accordance with said candidate first activity pattern.

8. The method according to claim 1, further comprising the step of requesting reassignment of an activity period based on periodic evaluation of one or more factors selected from the group consisting of Quality of Service (QoS), RF parameters, estimated channel characteristics and link quality.

9. The method according to claim 1, wherein said at least one candidate second activity pattern is initially based on Sleep, Scan and/or Idle mode detection.

10. The method according to claim 1, wherein said step of determining is performed by a centralized coordination manager.

11. The method according to claim 1, wherein said step of determining is performed by one or more distributed coordination managers.

12. The method according to claim 1, wherein said determined first activity pattern and said determined candidate second activity pattern ensures radio frequency (RF) coexistence between said first RAT and said second RAT.

13. The method according to claim 1, wherein said first and second activity patterns support flexible assignments of irregular transmission and reception availability periods.

14. A method of transmission and reception allocation of availability periods for multiple radio access technologies (RATs) in a single communication device, said method comprising the steps of:
determining a first activity pattern for a first RAT;
determining a proposed second activity pattern for a second RAT based on said first activity pattern and zero or more constraints of said second RAT; and
negotiating an activity mode with a second RAT network element to meet said proposed second activity pattern.

15. The method according to claim 14, further comprising the step of requesting reassignment of an availability period based on periodic evaluation of one or more factors selected from the group consisting of Quality of Service (QoS), RF parameters, estimated channel characteristics and link quality.

16. The method according to claim 14, further comprising the step of renegotiating an activity mode and activity pattern for said first RAT in the event said negotiation fails based on said proposed second activity pattern.

17. The method according to claim 14, further comprising the step of negotiating activity modes and activity patterns for one or more additional RATs based on activity patterns for said first and second RATs.

18. The method according to claim 14, wherein said proposed second activity pattern and said first activity pattern ensures radio frequency (RF) coexistence between said first RAT and said second RAT.

19. The method according to claim 14, wherein said communication device is adapted to operate over a set of one or more networks selected from the group consisting of Global System for Mobile communication (GSM), Worldwide Interoperability for Microwave Access (WiMAX), Wireless Local Area Network (WLAN), Bluetooth Personal Area Network (PAN), Code Division Multiple Access (CDMA), Universal Mobile Telecommunications (UMTS) and 3^{rd} generation long-term evolution (3GPP-LTE).

20. The method according to claim 14, wherein said activity mode comprises a combination of Sleep, Scan or Idle modes.

21. The method according to claim 14, wherein said first activity pattern is selected to ensure radio frequency (RF) coexistence between said first RAT and said second RAT.

22. The method according to claim 14, wherein said first activity pattern and said proposed second activity pattern consider one or more factors selected from the group consisting of Quality of Service (QoS), RF parameters, estimated channel characteristics and link quality.

23. The method according to claim 14, wherein said first activity pattern and said proposed second activity pattern consider physical layer (PHY) capabilities of said first RAT and said second RAT.

24. The method according to claim 14, wherein said first activity pattern and said proposed second activity pattern consider Medium Access Control (MAC) capabilities of said first RAT and said second RAT.

25. The method according to claim 14, wherein said first activity pattern and said proposed second activity pattern transmissions and receptions comprise burst transmissions and receptions.

26. The method according to claim 14, wherein information to be transmitted by said first RAT and said second RAT is buffered during unavailability periods of their respective activity patterns.

27. The method according to claim 26, further comprising the step of renegotiating at least one activity and/or inactivity pattern based on the state of said buffer.

28. The method according to claim 14, wherein said first and second activity patterns support flexible assignments of irregular transmission and reception availability periods.

29. A method of transmission and reception allocation of availability periods for multiple radio access technologies (RATs) in a single communication device, said method comprising the steps of:
determining a first activity pattern for a first RAT;
determining a proposed second activity pattern for a second RAT based on said first activity pattern and zero or more constraints of said second RAT; and
negotiating an activity mode with a first RAT network element to meet said proposed first activity pattern.

30. The method according to claim 29, further comprising the step of requesting reassignment of an availability period based on periodic evaluation of one or more factors selected from the group consisting of Quality of Service (QoS), RF parameters, estimated channel characteristics and link quality.

31. The method according to claim 29, further comprising the step of negotiating activity modes and activity patterns for one or more additional RATs based on activity patterns for said first and second RATs.

32. The method according to claim 29, wherein said proposed second activity pattern and said first activity pattern are selected to ensure radio frequency (RF) coexistence between said first RAT and said second RAT.

33. The method according to claim 29, wherein said communication device is adapted to operate over a set of one or more networks selected from the group consisting of Global System for Mobile communication (GSM), Worldwide Interoperability for Microwave Access (WiMAX), Wireless Local Area Network (WLAN), Bluetooth Personal Area Network (PAN), Code Division Multiple Access (CDMA), Universal Mobile Telecommunications (UMTS) and 3^{rd} generation long-term evolution (3GPP-LTE).

34. The method according to claim 29, wherein said activity mode comprises a combination of Sleep, Scan or Idle modes.

35. The method according to claim 29, wherein said first activity pattern and said proposed second activity pattern consider one or more factors selected from the group consisting of Quality of Service (QoS), RF parameters, estimated channel characteristics and link quality.

36. The method according to claim 29, wherein said first activity pattern and said proposed second activity pattern consider physical layer (PHY) capabilities of said first RAT and said second RAT.

37. The method according to claim 29, wherein said first activity pattern and said proposed second activity pattern consider Medium Access Control (MAC) capabilities of said first RAT and said second RAT.

38. The method according to claim 29, wherein said first activity pattern and said proposed second activity pattern transmissions and receptions comprise burst transmissions and receptions.

39. The method according to claim 29, wherein information to be transmitted by said first RAT and said second RAT is buffered during unavailability periods of their respective activity patterns.

40. The method according to claim 39, further comprising the step of renegotiating at least one activity and/or inactivity pattern based on the state of said buffer.

41. The method according to claim 29, wherein said first and second activity patterns support flexible assignments of irregular transmission and reception availability periods.

42. A method of transmission and reception coordination of allocation of availability periods for use in a multiple radio access technology (multi-RAT) device, the method comprising the steps of:
determining requested activity patterns and/or modes of operation of a plurality of RATs by a central coordination controller;
calculating an operating mode and transmission allocation of availability periods for each respective RAT based on said activity patterns and/or modes of operation of respective RATs and TX/RX priority of said plurality of RATs; and
configuring said plurality of RATs in accordance with each respective calculated operating mode and transmission allocation of availability periods.

43. The method according to claim 42, wherein said TX/RX priority of said plurality of RATs is determined a priori.

44. The method according to claim 42, wherein said TX/RX priority of said plurality of RATs is determined and/or negotiated dynamically.

45. The method according to claim 42, further comprising the step of requesting reassignment of operating mode and transmission allocation of availability periods based on periodic evaluation one or more factors selected from the group consisting of Quality of Service (QoS), RF parameters, estimated channel characteristics and link quality.

46. The method according to claim 42, wherein the operating mode and transmission allocation of availability periods for each respective RAT are calculated to ensure radio frequency (RF) coexistence between said plurality of RATs.

47. An apparatus for transmission and reception coordination of allocation of availability periods of multiple radio access technologies (RATs) incorporated within a communications device, comprising:
a plurality of distributed coordination managers, each coordination manager associated with a RAT;
an analysis unit associated with each coordination unit and operative to determine an allocation of availability periods based on TX/RX availability periods of other RATs in said device and TX/RX priority of said RATs; and
enabling operation of a respective RAT in accordance with a corresponding said determined allocation of availability periods.

48. The apparatus according to claim 47, wherein said allocation of availability periods is determined based on detection of one or more activity patterns.

49. The apparatus according to claim 47, wherein said allocation of availability periods is determined based on conveyance of one or more activity patterns.

50. The apparatus according to claim 47, wherein said allocation of availability periods is determined based on one or more activity patterns obtained by a synchronization process.

51. The apparatus according to claim 47, further comprising a negotiation unit operative to negotiate an allocation of availability periods for a particular RAT with a corresponding RAT network element.

52. The apparatus according to claim 51, wherein, if said negotiation is not successful:
said analysis unit operative to determine an alternative allocation of availability periods for said particular RAT; and
said negotiation unit operative to negotiate said alternative allocation of availability periods for said particular RAT with a corresponding RAT network element.

53. The apparatus according to claim 47, wherein said coordination manager is operative to request reassignment of the allocation of availability periods based on periodic evaluation of one or more factors selected from the group consisting of Quality of Service (QoS), RF parameters, estimated channel characteristics and link quality.

54. An apparatus for coordinating transmission and reception allocation of availability periods of multiple radio access technologies (RATs) incorporated within a communications device, comprising:
a centralized coordination manager operative to determine one or more allocations of availability periods based on determined activity patterns of a plurality of RATs in said device and TX/RX priority of said RATs; and
enabling operation of one or more RATs in accordance with corresponding said determined allocations of availability periods.

55. The apparatus according to claim 54, wherein said RATs are selected from the group consisting of Global System for Mobile communication (GSM), Worldwide Interoperability for Microwave Access (WiMAX), Wireless Local Area Network (WLAN), Bluetooth Personal Area Network (PAN), Code Division Multiple Access (CDMA), Universal Mobile Telecommunications (UMTS) and 3^{rd} generation long-term evolution (3GPP-LTE).

56. The apparatus according to claim 54, wherein said allocation of availability periods is determined based on detection of one or more activity patterns.

57. The apparatus according to claim 54, wherein said allocation of availability periods is determined based on conveyance of one or more activity patterns.

58. The apparatus according to claim 54, wherein said allocation of availability periods is determined based on one or more activity patterns obtained by a synchronization process.

59. The apparatus according to claim 54, further comprising a negotiation unit operative to negotiate an allocation of availability periods for a particular RAT with a corresponding RAT network element.

60. The apparatus according to claim 59, wherein, if said negotiation is not successful:
said centralized coordination manager operative to determine an alternative allocation of availability periods for said particular RAT; and
said negotiation unit operative to negotiate said alternative allocation of availability periods for said particular RAT with a corresponding RAT network element.

61. The apparatus according to claim 54, wherein said coordination manager is operative to request reassignment of the allocation of availability periods based on periodic evaluation of one or more factors selected from the group consisting of Quality of Service (QoS), RF parameters, estimated channel characteristics and link quality.

62. A communications device, comprising:
a first radio transceiver and associated media access control (MAC) operative to receive and transmit signals over a first radio access network (RAN) using a first wireless access;
a second radio transceiver and associated MAC operative to receive and transmit signals over a second RAN using a second wireless access;
a coordination manager for determining at least one candidate second activity pattern for transmission and/or reception opportunities/avoidance to a second RAN based on said first activity pattern;
enabling operation of said second RAN in accordance with said candidate second activity pattern; and
a processor operative to send and receive data to and from said first radio transceiver and said second radio transceiver.

63. The communication device according to claim 62, wherein said first wireless access and said second wireless access are selected from the group consisting of Global System for Mobile communication (GSM), Worldwide Interoperability for Microwave Access (WiMAX), Wireless Local Area Network (WLAN), Bluetooth Personal Area Network (PAN), Code Division Multiple Access (CDMA), Universal Mobile Telecommunications (UMTS) and 3^{rd} generation long-term evolution (3GPP-LTE).

64. The communication device according to claim 62, wherein said first coordination control unit comprises:
means for receiving an activity pattern for said second radio transceiver;
means for generating, based on said activity pattern, a proposed activity pattern for said first radio transceiver; and
means for negotiating an activity mode with said first RAN to meet said proposed activity pattern.

65. The communication device according to claim 62, wherein said second allocations of availability periods coordination control unit comprises:
means for determining an activity pattern for said first radio transceiver;
means for generating, based on said activity pattern, a proposed activity pattern for said second radio transceiver; and
means for negotiating an activity mode with said second RAN to meet said proposed activity pattern.

66. A computer-readable medium having computer readable instructions stored thereon for execution by a processor to perform a method of transmission and reception allocation of availability periods for use with a plurality of radio access technologies (RATs) including a first RAT with a first activity pattern, the method comprising the steps of:
determining at least one candidate second activity pattern for transmission and/or reception opportunities/avoidance to a second RAT based on said first activity pattern; and
enabling operation of said second RAT in accordance with said candidate second activity pattern.
